(19) United States
(12) Patent Application Publication
(10) Pub. No.: US 2026/0125523 A1
(43) Pub. Date: May 7, 2026

(54) FLUXIONAL CARBON CAGE POLYMER NETWORKS

(71) Applicant: University of Washington, Seattle, WA (US)

(72) Inventors: Matthew Golder, Seattle, WA (US); Peiguan Sun, Seattle, WA (US)

(73) Assignee: University of Washington, Seattle, WA (US)

(21) Appl. No.: 19/382,134

(22) Filed: Nov. 6, 2025

Related U.S. Application Data
(60) Provisional application No. 63/717,100, filed on Nov. 6, 2024.

(51) Int. Cl. C08J 3/24; C08F 2/52; C08F 220/18; C08G 83/00

(52) U.S. Cl. CPC C08J 3/246; C08F 2/52; C08F 220/1804; C08F 220/1808; C08G 83/001; C08J 2400/22; C08J 2400/24; C08J 2400/26

(57) ABSTRACT

Polymer networks including one or more polymers and a fluxional carbon cage are described. The fluxional carbon cage covalently crosslinks the one or more polymers to form the polymer network. Methods to synthesize the polymer network include preparing a fluxional carbon cage crosslinker, combining the fluxional carbon cage crosslinker with monomers and/or one or more polymers and a free radical initiator to form a mixture, and exposing the mixture to thermal energy and/or electromagnetic energy to form the polymer network.

### CROSS-REFERENCE TO RELATED APPLICATION

This application claims priority to U.S. Provisional App. No. 63/717,100, which was filed on Nov. 6, 2024 and is incorporated by reference herein in its entirety.

### STATEMENT REGARDING FEDERALLY SPONSORED RESEARCH

This invention was made with government support under Grant No. W911NF2310106, awarded by the U.S. Army Research Office. The government has certain rights in the invention.

### FIELD OF THE DISCLOSURE

The present disclosure relates to force responsive materials and polymer mechanochemistry. Particularly, improvements to polymer network structures within force responsive materials to provide energy absorption, improved strength, and lowered fragility are described.

### BACKGROUND

Recent advances in polymer mechanochemistry have led to the development of force responsive materials. Force responsive materials include polymers that contain force-sensitive molecules (e.g., mechanophores) designed to undergo a chemical transformation when a mechanical force is applied to the material. Mechanophores are specific molecular units embedded within a polymer chain that are sensitive to tensile, shear, and compressive forces. For example, when a force responsive polymer material is stressed, the mechanical force is transmitted through the polymer chain(s) to the mechanophores. Incorporating force-responsive small molecules (e.g., mechanophores) into polymer networks can introduce properties such as cargo release, wherein a specific molecular cargo, such as a drug, catalyst, dye, etc., attached to the mechanophore is deliberately detached from the larger molecular structure when mechanical force is applied, or stress visualization, wherein embedded molecules act as sensors to produce a visual output, such as color change, fluorescence, luminescence, etc., that maps and quantifies mechanical forces within a material.

Many force-responsive material systems are prized, however, for their “sacrificial bonds” that can dissipate exogenous force and enhance mechanical properties. Materials with such bonds can generally be separated into two categories-non-covalent (“low force” activation) (FIG. 1, panel A) and covalent (“high force” activation) (FIG. 1, panel B) depending on how the mechanically-active units are structured. Non-covalent systems take advantage of supramolecular interactions and/or mechanical bonds; specific examples include soft materials containing folded proteins, π-π aromatic stacking hydrogen-bonding, metal-organic motifs, rotaxanes, and catenanes. Adaptations in these systems are generally reversible with low activation barriers. On the other hand, systems bearing covalent mechanophores use higher energy barrier chemical transformations to adapt to applied mechanical force (e.g., pericyclic reaction). Specific examples include reversible retro-[4+2] Diels-Alder reactions for adaptable materials and non-reversible cycloreversions for tear resistance or toughening.

### SUMMARY OF DISCLOSURE

This Summary is provided to introduce a selection of concepts in a simplified form that is further described below in the Detailed Description. This Summary is not intended to identify all key features or essential features of the claimed subject matter, nor is it intended to be used alone as an aid in determining the scope of the claimed subject matter.

The present disclosure presents a novel class of “low force” activation materials mediated by covalent bonds (i.e., chemical reactions). The low force bonds of non-covalent interactions can provide reversible energy absorption and self-recovery, however they also introduce a trade-off between strength and recovery. Increasing the density of weak reversible bonds, for example, enhances toughness but can reduce stiffness and long-term strength of a material. Non-covalent interactions may require long times or specific conditions (heat, moisture) to re-form after deformation. Non-covalent bonds may also be susceptible to environmental sensitivity, for example, hydrogen bonding and metal-ligand coordination can be influenced by humidity, pH, or temperature, affecting performance consistency. Covalent, high-force bonds offer advantages over non-covalent bonds to deliver robust toughness and fracture resistance in force responsive materials as they are able to deform, absorb shocks, and recover from mechanical stress. Challenges remain, however, in achieving fully reversible, durable, and scalable molecular systems that use covalent bonds. Many covalent mechanochemical reactions are one-time events. After activation, they cannot reform, leading to fragility and permanent structural degradation over repeated cycles. Furthermore, synthetic complexity of force responsive materials, including the positioning of mechanophores and control of network architecture, has made it difficult and costly to achieve substantial advancements in these materials as well as production on an industrial scale.

Polymer networks of the present disclosure can include one or more polymers and a fluxional carbon cage, wherein the fluxional carbon cage covalently crosslinks the one or more polymers to form the polymer network.

An example method of synthesizing a polymer network of the present disclosure includes preparing a fluxional carbon cage crosslinker, combining the fluxional carbon cage crosslinker with monomers and/or one or more polymers and a free radical initiator to form a mixture, and exposing the mixture to thermal energy and/or electromagnetic energy to form the polymer network.

### BRIEF DESCRIPTION OF THE DRAWINGS

FIG. 1 illustrates an overview of mechanically-responsive soft materials making use of (A) “low force” supramolecular interactions or mechanical bonds, (B) “high force” covalent bonds, and (C) “low force” shapeshifting covalent molecular cages (e.g., bullvalene).

FIG. 2 illustrates (A) an illustration of rapid bullvalene Hardy-Cope rearrangements; (B) Bullvalene adjusts equilibrium population upon guest-host interactions; and (C) Bullvalene employed as single molecule circuit junction capable of adapting to scanning tunneling microscopy breakjunction (STMBJ) movement.

FIGS. 3A and 3B illustrate Scheme 1: the synthesis of X-Net-Y Polymer Networks (3A) the synthesis of Bull-DA; and (3B) the preparation of n-butyl acrylate thermosets (X-Net-Y).

FIGS. 4A-4C illustrate modulated differential scanning calorimetry (MDSC) X-Net-Y total heat flow curves for (4A) 7 mol % crosslinker loading (Y=7), (4B) 5 mol % crosslinker loading (Y=5), including “mixed” materials derived from Bull-DA and Ad-DA, and (4C) 2% crosslinker loading (Y=2).

FIGS. 5A and 5B illustrate (5A) temperature sweep experiments (1 Hz) of X-Net-7 materials; and (5B) arrhenius plots of T_{g,DMA} of X-Net-7 materials.

FIGS. 6A and 6B illustrate master curves for Ad-Net-7 and Bull-Net-7 detailing (6A) storage (E′) and loss (E″) moduli and (6B) Tan (δ) (grey lines indicate differences in high frequency region).

FIGS. 7A-7D illustrate (7A) VT 1H Nuclear Magnetic Resonance (NMR) spectrum of Bull-DA; and cyclic loading of X-Net-Y materials: (7B) Y=7, (7C) Y=5; (7D) Y=2.

FIG. 8 illustrates that (left) Bullvalene adapts to applied force (right) through chain alignment governed by mechanically-guided and/or mechanically-activated Hardy-Cope rearrangements.

FIG. 9 illustrates a representative proposed mechanism of action where mechanically-activated and mechanically-guided Hardy-Cope rearrangements facilitate mechanical energy absorption in Bull-Net-Y materials.

FIG. 10 illustrates that bullvalene functions as a reversable covalent mechanophore in polymer networks.

FIG. 11 illustrates a Bullvalene radical stability test, stacked ¹H NMR spectra of a mixture of tetramethylsilane (TMS)-Bullvalene and 2,2′-azobis(2,4-dimethyl-4-methoxyvaleronitrile) (V-70) at T₀ at (A) 25° C., (B) 0° C.; (C) decomposed V-70 initiator; mixture of TMS-Bullvalene and V-70 after heating at 60° C. for 16 h at (D) 25° C., (E) 0° C.

FIG. 12 illustrates thermal gravimetric analysis (TGA) curves of X-Net-7 materials cured with X-DA at heating rate of 10° C./min.

FIG. 13 illustrates small-angle X-ray Scattering (SAXS) curves of Bull-Net-7 and Ad-Net-7.

FIG. 14 illustrates storage modulus from frequency sweep experiments of X-Net-7 at 20° C.

FIGS. 15A-15C illustrate MDSC Curves of X-Net-Y materials.

FIG. 16 illustrates equilibrium swelling ratios of X-Net-7 materials in various solvents.

FIG. 17 illustrates a temperature sweep experiment at different frequencies for Bull-Net-7.

FIG. 18 illustrates a temperature sweep experiment at different frequencies for Ad-Net-7.

FIG. 19 illustrates a temperature sweep experiment at different frequencies for Hex-Net-7.

FIG. 20 illustrates a temperature sweep experiment at different frequencies for Bull-Net-5.

FIG. 21 illustrates a temperature sweep experiment at different frequencies for Bull_{2.5}Ad_{2.5}-Net-5.

FIG. 22 illustrates a temperature sweep experiment at different frequencies for Bull_{1.25}Ad_{3.75}-Net-5.

FIG. 23 illustrates a temperature sweep experiment at different frequencies for Ad-Net-5.

FIG. 24 illustrates a temperature sweep experiment at different frequencies for Bull-Net-2.

FIG. 25 illustrates a temperature sweep experiment at different frequencies for Ad-Net-2.

FIGS. 26A and 26B illustrate compiled values of Eₐ for glass transition for X-Net-5 and X-Net-2.

FIG. 27 illustrates master curve shift factor as a function of temperature for Bull-Net-7 fitted to the Williams-Landel-Ferry (WLF) function by TA TRIOS software.

FIG. 28 illustrates master curve shift factor as a function of temperature for Ad-Net-7 fitted to the WLF function by TA TRIOS software.

FIG. 29 illustrates cyclic loading experiments for X-Net-7 at 20° C., 2% strain/min.

FIG. 30 illustrates cyclic loading experiments for Bull-Net-7 at 20° C., 2% strain/min, n=3 specimens.

FIG. 31 illustrates cyclic loading experiments for Ad-Net-7 at 20° C., 2% strain/min, n=3 specimens.

FIG. 32 illustrates cyclic loading experiments for Hex-Net-7 at 20° C., 2% strain/min, n=3 specimens.

FIG. 33 illustrates cyclic loading experiments for Bull-Net-7 at −40° C., 2% strain/min, n=3 specimens.

FIG. 34 illustrates cyclic loading experiments for Ad-Net-7 at −40° C., 2% strain/min, n=3 specimens.

FIG. 35 illustrates cyclic loading experiments for Hex-Net-7 at −40° C., 2% strain/min, n=3 specimens.

FIG. 36 illustrates successive cyclic loading test of a single Bull-Net-7 specimen at −40° C., 2% strain/min.

FIG. 37 illustrates successive cyclic loading test of a single Ad-Net-7 specimen at −40° C., 2% strain/min.

FIG. 38 illustrates successive cyclic loading test of a single Hex-Net-7 specimen at −40° C., 2% strain/min.

FIG. 39 illustrates measurement of thermal expansion coefficients. For both Ad-Net-7 and Bull-Net-7 samples, the thermal expansion coefficients were found to be 3.1×10-4° C.⁻¹ and 2.3×10-4° C.-1, respectively. These small values indicate that the length changes less than 1.5% from −40° C. to 20° C., or equivalently a density change of less than 5% across a temperature range of 60° C. The relative differences between Ad-Net-7 and Bull-Net-7 samples are within the error of this measurement.

FIG. 40 illustrates sequential loading of a Bull-Net-7 specimen to 15% strain at 2% strain/min at −40° C. After each cycle, the specimen was warmed to room temperature and then cooled back to −40° C.

FIG. 41 illustrates sequential loading of an Ad-Net-7 specimen to 15% strain at 2% strain/min at −40° C. After each cycle, the specimen was warmed to room temperature and then cooled back to −40° C.

FIG. 42 illustrates sequential loading of a Hex-Net-7 specimen to 15% strain at 2% strain/min at −40° C. After each cycle, the specimen was warmed to room temperature and then cooled back to −40° C.

FIGS. 43A and 43B illustrate (43A) an overview of Angell fragility, a descriptor of how rapidly viscosity changes as a function of temperature, and (43B) crosslinker structure impacts glass formation in polymer thermosets presented herein.

FIG. 44 illustrates preparation of poly(methyl methacrylate) (PMMA) networks (X-Y).

FIG. 45 illustrates synthesis of fluxional crosslinker bullvalenyl diacrylate (Bull-DA).

FIG. 46 illustrates synthesis of control static crosslinker adamantane diacrylate (Ad-DA).

FIGS. 47A and 47B illustrate master curves detailing storage (E′), loss (E″) moduli and Tan (δ) of (47A) Bull-7 and (47B) Ad-7.

FIGS. 48A and 48B illustrate Angell plots of Bull-Y and Ad-Y at (48A) 2 mol % crosslink density and (48B) 7 mol % crosslink density.

FIG. 49 illustrates photographs of (A) curing mold between two glass slides secured with binder clips; (B) the mold containing the resin placed in a vertically standing nail curing lamp; (C) materials after water jetting; and (D) individual DMA bar and dog bone specimens.

FIG. 50 illustrates TGA curves of X-Y materials at heating rate of 10° C./min.

FIG. 51 illustrates Differential Scanning calorimetry (DSC) Curves of X-Y materials.

FIG. 52 illustrates stress strain curves measured using uniaxial tensile testing for Bull-7 and Ad-7 (strain rate of 1 mm/min, n=2).

FIG. 53 illustrates Tan (o) curves from Dynamic Mechanical Analysis (DMA) temperature sweep experiments of X-Y materials (1 Hz, 0.015% strain, 3° C./min ramp rate).

FIG. 54 illustrates a master curve of Ad-2 network generated from frequency sweep experiments every 3° C. from 130° C. to 169° C.

FIG. 55 illustrates a master curve of Bull-2 network generated from frequency sweep experiments every 3° C. from 130° C. to 169° C.

FIG. 56 illustrates a WLF Fit of Bull-7 (Tᵣₑₜ=T_{g}).

FIG. 57 illustrates a WLF Fit of Ad-7 (Tᵣₑₜ=T_{g}).

FIG. 58 illustrates a WLF Fit of Bull-2 (Tᵣₑₜ=T_{g}).

FIG. 59 illustrates a WLF Fit of Ad-2 (Tᵣₑₜ=T_{g}).

FIG. 60 illustrates a WLF Fit of Bull-BA-7 (Tᵣₑₜ=T_{g}+15° C., data obtained from Ref. 1).

FIG. 61 illustrates a WLF Fit of Ad-BA-7 (T_{ref}=T_{g}+15° C., data obtained from Ref. 1).

### DETAILED DESCRIPTION

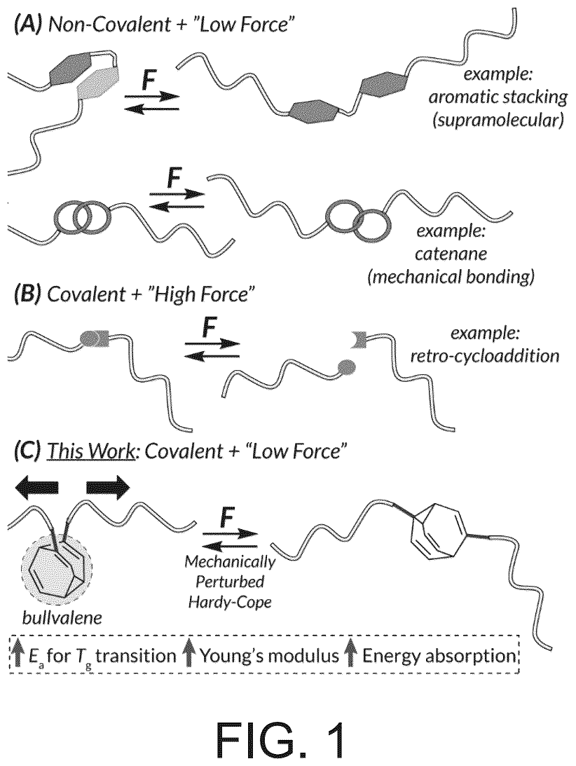

The present disclosure presents a class of “low force” activation force responsive materials. The force responsive materials presented herein include “shapeshifting” molecular cages mediated by covalent bonds within polymer networks that exhibit novel energy absorption motifs (see, e.g. FIG. 1, panel C). The present disclosure also presents methods for the synthesis of the force responsive materials presented herein, including scalable methods for modulating the density of “shapeshifting” molecular cages and controlling network architecture.

Force-responsive materials are advanced polymers designed to transfer mechanical energy into a measurable or functional chemical response. Mechanical energy can include tensile forces such as stretching; compression or impact forces; shear forces such as those occurring at sliding interfaces of coatings or adhesives; or vibrational forces such as ultrasonic agitation. Force-responsive materials typically include mechanophores, which are force-sensitive molecular units embedded within a polymer network that mediate the materials' response to a given force. Mechanophores can act as “molecular transducers,” converting mechanical force into chemical, optical, or structural changes. Mechanophores can be integrated in the main chain of a polymer, as crosslinkers between polymer chains, as side-chain pendants that experience secondary stress transfer, or combinations thereof. Common mechanophores include spiropyrans which can undergo isomerization to produce color and/or polarity changes; gem-dihalocyclopropanes which can undergo bond scission or cleavage of covalent bonds (e.g., gem-dihalocyclopropane ring opening); dioxetanes which can undergo chemiluminescent emission to generating light under stress; Diels-Alder adducts that can undergo cycloreversions to dissociate under load and in some cases re-form upon relaxation; and metal-ligand complexes that can reversibly break and reform under stress.

The term mechanical force, as used herein can include a compressive force, a shear force, or a tensile force and wherein the mechanical force can include a static force, an oscillating force, a vibrational force, or an intermittent force

The polymer matrix of a force-responsive material can include thermosetting polymers and thermoplastic polymers. For example, the thermosetting polymers and thermoplastic polymers described herein can include elastomers and resins. In implementations, the thermosetting polymers and thermoplastic polymers of the present disclosure can be used to make materials such as hydrogels and organogels. This matrix serves to distribute and focus mechanical loads onto the mechanophores. Crosslinking density, molecular weight, and polymer architecture (linear, branched, or networked) can influence how efficiently stress is transmitted within the force responsive material and where activation of the mechanophores occurs. In various cases, the polymer matrix of the force responsive materials described herein can include a polymer matrix that includes one or more polymers within a polymer network that are covalently crosslinked by one or more fluxional carbon cage. In implementations, a polymer of the present disclosure can be formed from monomers such as an acrylate monomer, an epoxy monomer, a methacrylate monomer, a styrene monomer, an acrylamide monomer, a diene monomer, a vinyl acetate monomer, or a acrylonitrile monomer. For example, the one or more polymers can include alkyl polyacrylate, alkyl polymethacrylate, aryl polyacrylate, aryl polymethacrylate, or combinations thereof. In some cases, the one or more polymers can include at least one of an acrylate polymer, a polyester, a polysiloxane, a polyamide, a polyether, a polyolefin, a poly(vinyl ether), a polystyrene, a polyimide, a polysulfone, or a polyurethane. In implementations, the fluxional carbon cage can make up 1 mol % to 99 mol % of the polymer network.

The terms “shapeshifting” molecular cage and “fluxional” carbon cage, as used herein, refer to molecules having 8-12 carbons forming a cage like structure and having 3-7 double bonds that undergo sigmatropic rearrangements about the molecule. A sigmatropic reaction (or rearrangement) includes a pericyclic organic chemical reaction in which one single bond (sigma bond) and one or more pi bonds (π-bonds) rearrange their positions within the same molecule in a single, concerted step through a cyclic transition state. The net result is that one sigma bond changes to another sigma bond at a different location, with a corresponding reorganization of the π-system. For example, the fluxional carbon cage can include a bullvalene, a barbaralyl cation, a barbaralyl radical, a barbaralane, a bullvalone, a barbaralone, or a semibullvalene. Barbaralyl can refer to the barbaralyl cation (C₉H₉⁺) or the barbaralyl radical, which are highly fluxional species. The neutral barbaralane compound is a related structure. Barbaralane (C₉H₁₀) is a neutral tricyclic hydrocarbon that is a prototypical fluxional molecule that undergoes rapid degenerate Cope rearrangements. Bullvalone is a ketone derivative of bullvalene (C₁₀H₁₀O), and barbaralone is a ketone derivative of barbaralane (C₉H₈O). Semibullvalene (C₈H₉) is a fluxional polycyclic hydrocarbon with a highly strained, cage-like fused-ring structure.

In some cases, the force responsive materials described herein can include combinations of two or more different fluxional carbon cages. In some cases, the force responsive materials described herein can include combinations of one or more fluxional carbon cage and one or more additional mechanophores.

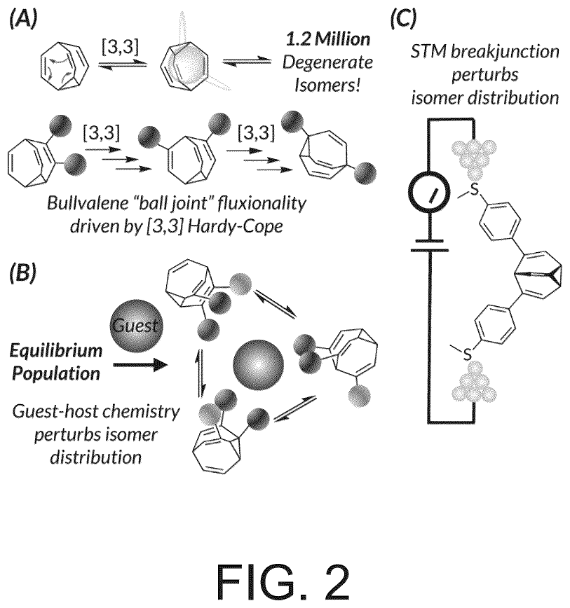

One of the most studied molecular shapeshifters, bullvalene, was first synthesized by Doering, Roth and Schröder in the 1960s and since then has fascinated chemists due to its unique molecular architecture. Bullvalene is a C₁₀ molecular cage that undergoes rapid [3,3] sigmatropic rearrangements (i.e., Hardy-Cope rearrangements) at room temperature due to its unique molecular architecture that orients the requisite C—C and C═C bonds in a pre-organized, boat-like transition state. Three alkenes emanating from a central carbon atom, organized symmetrically in a boat conformation, and connected by a strained cyclopropane ring sets up ideal conditions for rapid Hardy-Cope rearrangements. Unsubstituted bullvalene has more than 1.2 million (10!/3) degenerate isomers rapidly interconverting (Eₐ=ca. 11 kcal/mol) at room temperature (FIG. 2, panel A). Substituted bullvalenes exist as an equilibrium population of different isomers that rapidly interconvert between each other (i.e., molecular ball joint).

Supramolecular interactions can perturb the interconversion of fluxional isomers for applications in molecular recognition (FIG. 2, panel B). Such substituted bullvalenes, when unperturbed, exist in an equilibrium distribution of valence isomers. Upon addition of analytes, bullvalene engages in guest-host interactions, shifting to a new equilibrium population. Accessing such multi-substituted bullvalenes, however, is difficult due to lengthy synthetic sequences. Recent progress in concisely accessing substituted bullvalenes reported by Fallon reignited interest for bullvalene applications. Most applications of bullvalene explored so far are solution-state, however.

Interestingly, examples of bullvalene rearrangements in the solid-state also exist. Specifically, dynamic behaviors were observed in unsubstituted bullvalene single crystals with an activation barrier for Hardy-Cope rearrangements resembling those in isotropic and liquid crystalline solutions. More recently, Darwish and Fallon demonstrate the mechanical control of bullvalene fluxionality in a scanning tunneling microscopy breakjunction (STMBJ); perturbed isomerization facilitates dynamic piezoresistance (FIG. 2, panel C). Recent work incorporated bullvalene into π-rich thermoplastics showing that stochastic bullvalene isomers could effectively modulate the rigidity of such polymers but left many unanswered questions about resultant thermomechanical behaviors.

Since bullvalene's valence isomer distribution can adapt to exogenous stimuli in solution and in the bulk (FIG. 2), it is hypothesized that upon applied mechanical force within a bulk material, the equilibrium population of fluxional carbon cage molecules, such as bullvalene, could adapt to the applied force vector. It is hypothesized that studying the thermomechanical properties of these materials can be useful to understand molecular-level sigmatropic rearrangements within polymer networks. It is demonstrated herein that reversible Hardy-Cope rearrangements can be perturbed through mechanical force, and unique thermoset properties emerge by bridging the gap between “low force” and “covalently bonded” force responsive materials in a strictly non-scissile system (FIG. 1, panel C).

Presented herein, are fluxional carbon cage molecules incorporated into elastomeric polymer networks. The thermal behavior and temperature-dependent viscoelastic properties of these materials are examined herein alongside control networks containing “static” crosslinkers. Using dynamic mechanical analysis (DMA), it is demonstrated that when a fluxional carbon cage which undergoes reversible Hardy-Cope rearrangement, is incorporated into a polymer matrix the material exhibits an increase in the activation barrier for the glass transition process, and also has distinct stiffening and energy dissipation behaviors below the glass transition temperature (i.e., glassy region). Furthermore, the present disclosure computationally explores the impact of external force on discrete bullvalene isomers and identify two plausible “mechanophore” pathways that may contribute to the observed properties. These collective thermal and mechanical properties unique to the force responsive thermosets described herein, provide credence for the consequences of molecular fluxionality on bulk materials properties.

Furthermore, while bullvalene has seen recent applications in molecular recognition, medicine, and organic electronics, little is known about the impact of incorporating fluxional carbon cage molecules in polymeric materials. The initial findings in bulk polymer matrices presented herein indicate that under tension, molecular fluxionality is driven by a combination of mechanically guided thermal rearrangements (i.e., slowly interconverting bullvalenes align to a force vector) and mechanically activated rearrangements (i.e., discrete bullvalene isomers function as force-driven mechanophores). These mechanistic phenomena transpire at the macroscopic level in materials that exhibit higher activation barriers to the glass transition process, enhanced energy dissipation, and increased stiffening.

Herein, fluxional carbon cage crosslinkers are incorporated polymer networks to examine the consequences of molecular fluxionality on glass formation. In implementations, a fluxional carbon cage of the present disclosure can include a molecule having the structure:

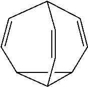

wherein carbons 1-10 of the fluxional carbon cage can include a substituent such as a hydrogen, a halogen, a hydroxyl group, an amino group, a carboxyl group, a carbonyl group, a nitro group, a thiol group, a cyano group, an alkyl group, or an aromatic group. In implementations, the fluxional carbon cage, when covalently crosslinked to one or more polymers within a polymer network can have the structure:

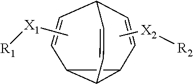

wherein X₁ and X₂ independently can include a functional group such as a hydrocarbon chain, an aromatic group, an amino group, a sulfur(S), or an oxygen (O), and R₁ can include a first sidechain of the one or more polymers and R₂ can include a second sidechain of the one or more polymers. In implementations, the R group, i.e. R₁, R₂, etc., encompasses the necessary functional group for connection with the X group, i.e. X₁, X₂, etc. In implementations, the hydrocarbon chain can include 1 to 10 carbons (C1 to C10), 1 to 7 carbons (C1 to C7), 1 to 5 carbons (C1 to C5), or 1 to 3 carbons (C1 to C3). The hydrocarbon can include an alkyl, an alkene, an alkenyl, or an alkynyl. For example, X₁ and X₂ can be the same functional group or a different functional group, and R₁ and R₂ can be the same moiety or different moieties. In some cases, the fluxional carbon cage covalently crosslinked to one or more polymers within a polymer network can include one non-hydrogen bond to a polymer chains, i.e. an X₁—R₁ group. In some cases, the fluxional carbon cage covalently crosslinked to one or more polymers within a polymer network can include up to four non-hydrogen bonds to the one or more polymer chains, i.e. an X₁—R₁ group, an X₂—R₂ group, an X₃—R₃ group, and an X₄—R₄ group. In implementations, substituents of the fluxional carbon cage isomerize about the molecule as a result of the reversible Hardy-Cope rearrangements. For example, when a hydrogen is replaced by a substituent (e.g., a hydroxyl group, an amino group, a carboxyl group, a carbonyl group, a nitro group, a thiol group, a cyano group, an alkyl group, an aromatic group, an X₁—R₁ group, an X₂—R₂ group, etc.), that substituent remains covalently attached to its specific carbon atom, but the Hardy-Cope rearrangements allow that the substituent to spontaneously explore every possible position in the overall molecular structure over time.

The term “low force” as used herein, refers to the fact that shapeshifting molecular cages have a “low” activation barrier, or minimum energy requirement for a sigmatropic rearrangement reaction to occur. For example, force responsive shapeshifting molecular cages described herein can have an activation barrier of 11 kcal/mol, which is lower than typical “high force” activation force responsive molecules which can have activation barriers above 25 kcal/mol. In implementations, the force responsive materials described herein can include a polymer network that includes at least one polymer strand covalently bound to a fluxional carbon cage. The sigmatropic rearrangement of the fluxional carbon cage can allow the at least one polymer strand to isomerize about the fluxional carbon cage in response to a mechanical force acting upon the strand. In some cases, the activation barrier of the fluxional carbon cage for the at least one polymer strand to isomerize about the fluxional carbon cage is in a range of 8 kcal/mol to 23 kcal/mol. In implementations, the fluxional carbon cage isomerizes in the direction of a force vector of the mechanical force upon application of the mechanical force, thereby stiffening the force responsive material.

The force responsive materials presented herein are the first to provide reversible energy absorption and self-recovery in a covalently bonded force responsive material. Unlike previous covalent, “high-force” bonds, the “low force” covalently bonded materials presented herein are fully reversible, durable, and scalable molecular systems that are able to deform, absorb shocks, and recover from mechanical stress. The force responsive materials presented herein, therefore, can provide flexibility and energy absorption, without sacrificing strength. Furthermore, unlike conventional low force non-covalently bonded force responsive materials, increasing the density of the covalently bonded molecular cages presented herein can enhance toughness without reducing stiffness and long-term strength of the material. Additionally, unlike “high force” mechanophores where covalent bonds break during deformation, the materials presented herein can maintain covalent bonds during deformation and are therefore reversable. The materials presented herein can also be less susceptible to environmental sensitivity, such as temperature.

Dynamic fragility of polymer glasses describes how steeply a material's viscosity changes as it passes through its glass transition; stronger glasses have a less steep transition than fragile glasses. Fragility is an important parameter in determining practical service temperature windows where mechanical properties remain predictable. At the molecular level, polymer chain flexibility usually is a key driver of fragility, ultimately dictating a balance of local molecular relaxation versus longer range segmental motion. Herein, molecular fluxionality is presented as a new motif to control fragility by exploiting fluxional Hardy-Cope rearrangements within glassy polymer networks. Thermosets crosslinked with a fluxional carbon cage, for example bullvalene, consistently show lower fragility (i.e., stronger glass) relative to static adamantane-derived control networks. Such strengthening through sigmatropic rearrangements within a hydrocarbon cage presents new insight into the impact of local molecular motion on glass formation and the applications of such materials.

Glass transition is a fundamental property of amorphous polymers, marking the transition from a viscous rubbery state to a brittle glassy state with decreasing temperature. Above the glass transition temperature, T_{g}, polymers exhibit low viscosity, while cooling through the glass transition causes a dramatic increase in viscosity. Upon further cooling into the glassy region, polymers become hard and brittle as the viscosity eventually plateaus. By tailoring a polymer's chemical structure, the glass transition temperature and mechanical properties can be manipulated for a target application. The versatile tunability of mechanical properties make glass-forming polymers ubiquitous across commodity plastics and engineering materials, so it would be advantageous to further understand and tune glass formation at the molecular level.

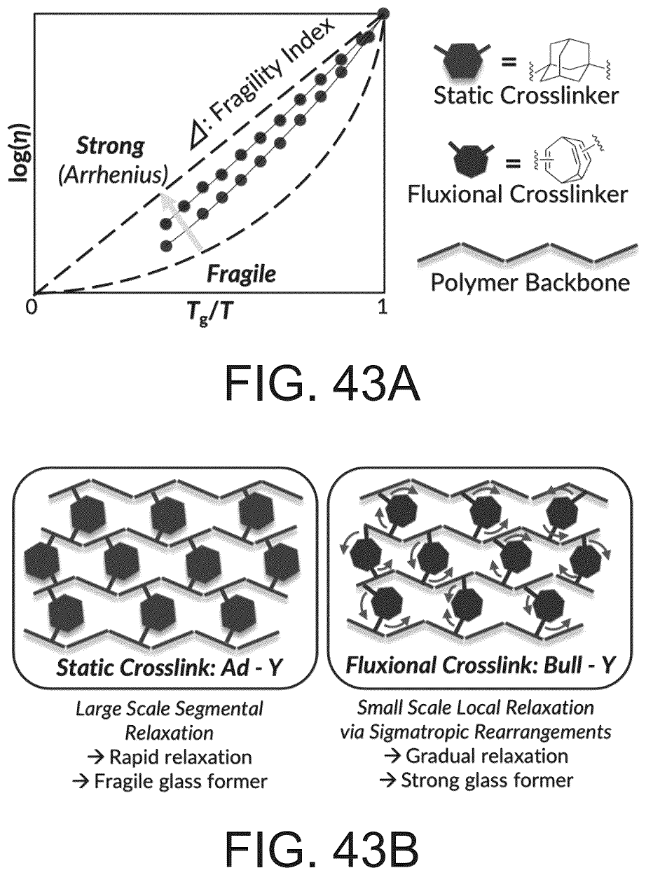

One key characteristic of the glass transition that differentiates glasses from one another is the steepness in which the viscosity increases as the material goes from a rubbery to glassy state. Such temperature dependence of viscosity was first proposed by Angell using the term dynamic fragility and was quantified through fragility index, m (vide infra). A steep increase in viscosity during glass formation leads to a fragile glass with higher m that deviates from Arrhenius behavior. In contrast, a strong glass has lower m where the modulus increase is gradual and more closely resembles Arrhenius behavior, ultimately leading to more predictable properties over a wider service temperature window. An Angell plot can be constructed to visualize these effects by plotting viscosity (i.e., log(η)) relative to T_{g}/T (FIG. 43A).

The magnitude of dynamic fragility for a specific material is largely dependent on local molecular and segmental motion that are impacted by molecular-level descriptors, such as chemical structure, backbone rigidity, and sidechain flexibility. Generally, as materials cool from a rubbery to glassy state, more rigid or sterically demanding polymers that lack local molecular relaxation pathways only relax via cooperative segmental motion. As temperature changes, long range cooperative motion alters material properties all at once, leading to rapid viscosity changes. Meanwhile, materials with flexible molecular structures resist these rapid changes in viscosity through local molecular relaxation, where the scale of relaxation is small and continuous. Such differences in the scale of relaxation are shown to be correlated to free volume (v₁₀), or the space that molecules have to reorient, at T_{g}. A high v₁₀ corresponds to each monomer unit being more constrained by neighboring units; motion is largely segmental over a longer range. On the other hand, lower v₁₀ indicates each individual monomer unit can move more freely and pack into tighter configurations through local molecular motion. In other words, polymers with simple, sterically unencumbered structures form stronger glasses, while polymers with rigid and sterically demanding structures are increasingly more fragile. In implementations, a force responsive material of the present disclosure can have a lower fragility than a similar material made up of the same one or more polymers, and having a higher mol % of a static crosslinker covalently crosslinking the one or more polymers.

The present disclosure also presents methods for the synthesis of the force responsive materials presented herein. In implementations, methods of synthesizing the force responsive materials described herein can include preparing a fluxional carbon cage crosslinker having the structure:

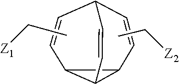

wherein the Z₁ and Z₂ independently can include an acrylate group or a methacrylate group. In implementations, Z₁ and Z₂ can include any functional group that can polymerize via radical polymerization, for example acrylates, methacrylates, vinyl groups, maleimides, vinylsulfones, allyl groups, and alkynes. For example, Z₁ and Z₂ can be the same moiety, or different moieties. The synthesis can then include combining the fluxional carbon cage crosslinker with monomers and/or one or more polymers and a free radical initiator to form a mixture. For example, the monomers can include at least one of: an acrylate monomer, an epoxy monomer, a methacrylate monomer, a styrene monomer, an acrylamide monomer, a diene monomer, a vinyl acetate monomer, or a acrylonitrile monomer. In some cases, the fluxional carbon cage can be combined with multiple polymers. For example, the fluxional carbon cage can be bound to multiple polymers that can be crosslinked by exogenous small molecules and/or polymers. In implementations, the fluxional carbon cage crosslinker can be 1 mol % to 99 mol % of the mixture, for example 1 mol % to 50 mol % of the polymer network, 1 mol % to 25 mol % of the polymer network, 1 mol % to 10 mol % of the polymer network, or 2 mol % to 7 mol % of the polymer network. In implementations, by controlling the crosslinker density and by adding mixtures of a static crosslinker (e.g., adamantane) and a fluxional carbon cage to the same material, the crosslinker density can be modulated.

The free radical initiator can include, for example a thermal and/or an electromagnetic initiator. In implementations, the mixture can include any free radical initiator known in the art for polymerization. For example, a thermal free radical initiator can include an azo compound such as 2,2′-azobis(4-methoxy-2,4-dimethylvaleronitrile) (V-70), 2,2′-azobis(isobutyronitrile) (AIBN), and 4,4′-Azobis(4-cyanovaleric acid, and organic peroxides such as benzoyl peroxide (BPO), tert-Butyl peroxide, and lauroyl peroxide (LPO). Thermal free radical initiators decompose when heated, generating free radicals to start chain reactions. In implementations, an electromagnetic initiator, or a photoinitiator, that responds to UV or visible light to form free radicals can be used. Photoinitiators can include a type I photoinitiators which can fragment directly, such as 2,2-Dimethoxy-2-phenylacetophenone (DMPA), benzoin methyl ether, and 4,4′-Dimethylbenzil, and, and Type II photoinitiators that may require a co-initiator such as benzophenone, 4,4′-Bis(diethylamino)benzophenone and 2,4-Diethyl-9H-thioxanthen-9-one. After forming the mixture, the method includes exposing the mixture to thermal energy and/or electromagnetic energy (light) to form a polymer network. In implementations, chain growth network formation can be used, for example combining monomer and crosslinker to form the polymer network. In some cases, step-growth polymerization methods where monomers, or larger oligomers, react in a step-by-step manner to form polymer chains, can be used to produce “defined” networks.

In implementations, the present disclosure includes kits for generating the polymer networks described herein. A kit, for example, can include a mixture of monomers, a fluxional carbon cage crosslinker, and a free radical initiator. The mixture can then be cured, for example by exposure to thermal energy and/or electromagnetic energy to activate the free radical initiator, to form the polymer network.

Specific implementations will now be described in the following Experimental Examples.

### EXPERIMENTAL EXAMPLES

### Example 1

The solution-state fluxional behavior of fluxional carbon cages, such as bullvalene, have fascinated physical organic and supramolecular chemists alike. Little effort, however, has been put into investigating applications for fluxional carbon cages in the bulk, partially due to difficulties in characterizing such dynamic systems. To address this knowledge gap, Experimental Example 1 investigates whether materials utilizing Hardy-Cope rearrangements can be mechanically perturbed in bulk polymer networks. Dynamic mechanical analysis is used to demonstrate that the activation barrier to the glass transition process is significantly elevated for materials containing a fluxional carbon cage, in this case bullvalene, relative to “static” control networks. Furthermore, Experimental Example 1 demonstrates that bullvalene rearrangements can be mechanically perturbed at low temperature in the glassy region; such behavior facilitates energy dissipation (i.e., increased hysteresis energy) and polymer chain alignment to stiffen the material (i.e., increased Young's modulus) under load. Computational simulations corroborate this work that showcases bullvalene as a reversible “low force” covalent mechanophores in the modulation of viscoelastic behavior.

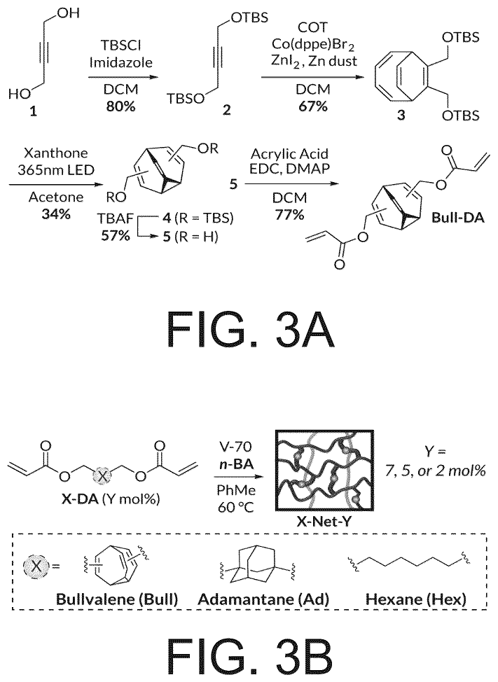

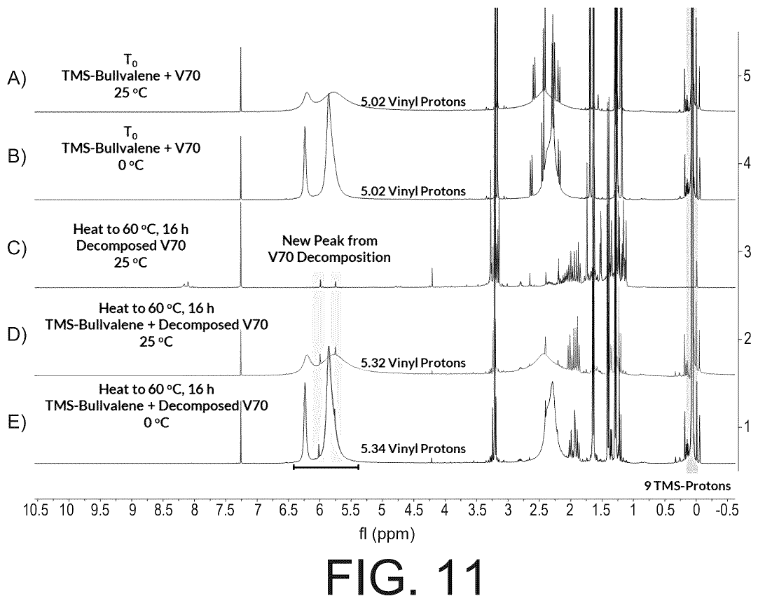

NETWORK SYNTHESIS. The requisite crosslinked elastomers for thermal and mechanical testing were synthesized from n-butyl acrylate and an appropriate diacrylate crosslinker under thermal free radical conditions (V-70, 60° C.) that testing has confirmed bullvalene tolerates (FIG. 11). Cross-linker loadings between 2-7 mol % were selected in preparation for thermal and mechanical experiments (i.e., X-Net-Y). The crosslinker for target bullvalene networks (Bull-Net-Y), bullvalene diacrylate (Bull-DA), is derived from dimethanol bullvalene 5, the product of Co-catalyzed formal [6+2] cycloaddition of silyl-protected 2-butyne-1,4-diol 2 and cyclooctatetraene (COT) after deprotection.^{51,58,64} Photo-chemical di-TT-methane rearrangement⁶⁵⁻⁶⁷ to 4 and subsequent esterification with acrylic acid affords Bull-DA (FIG. 3A). In the selection of control “static” crosslinkers, adamantane diacrylate (Ad-DA) was chosen. Bullvalene and adamantane are both C₁₀ hydrocarbon cages with similar molar masses. Conveniently, substituents on adamantane are also situated in a non-planar fashion, akin to bullvalene's geometry. As Bull-DA and Ad-DA should have similar steric profiles, the effect of crosslinker topology and fluxionality on bulk materials properties can be investigated through synthesis of Ad-Net-Y. These two X-DA crosslinkers were used to access homogeneous X-Net-Y materials (Y=7, 5, and 2 mol %), as well as “mixed” Bull_{2.5}Ad_{2.5}-Net-5 and Bull_{1.25}Ad_{3.75}-Net-5 materials to further interrogate the role of bullvalene within crosslinked materials. In addition, crosslinker rigidity was controlled for by utilizing commercially available 1,6-hexanediol diacrylate (Hex-DA) as a second control crosslinker towards Hex-Net-Y (FIG. 3B).

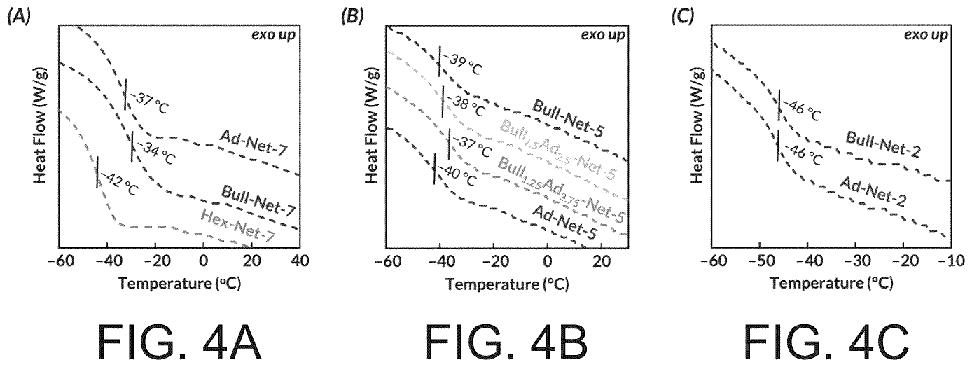

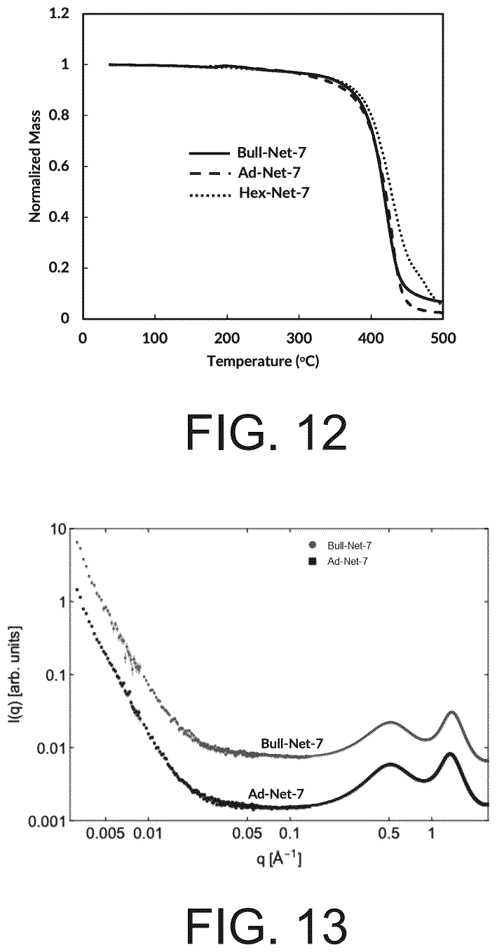

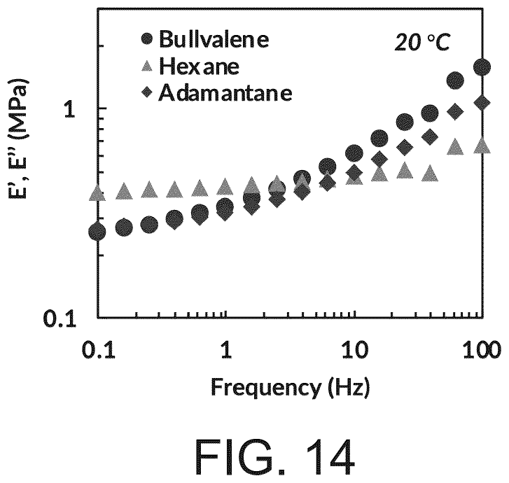

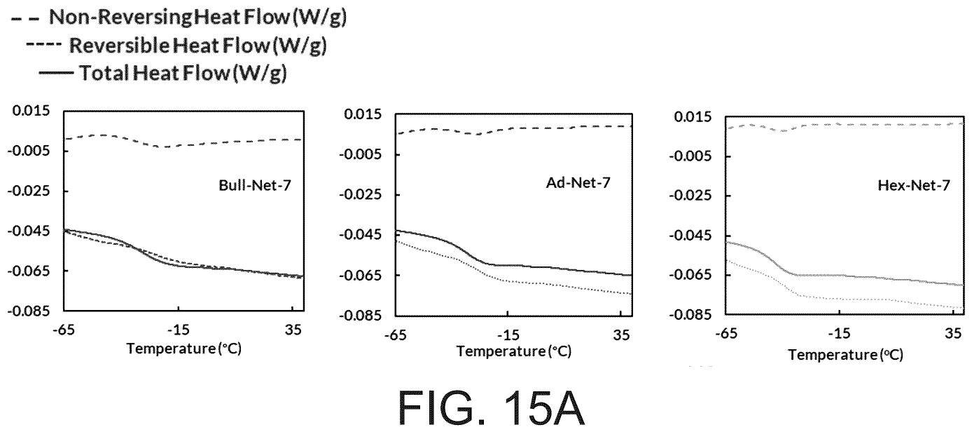

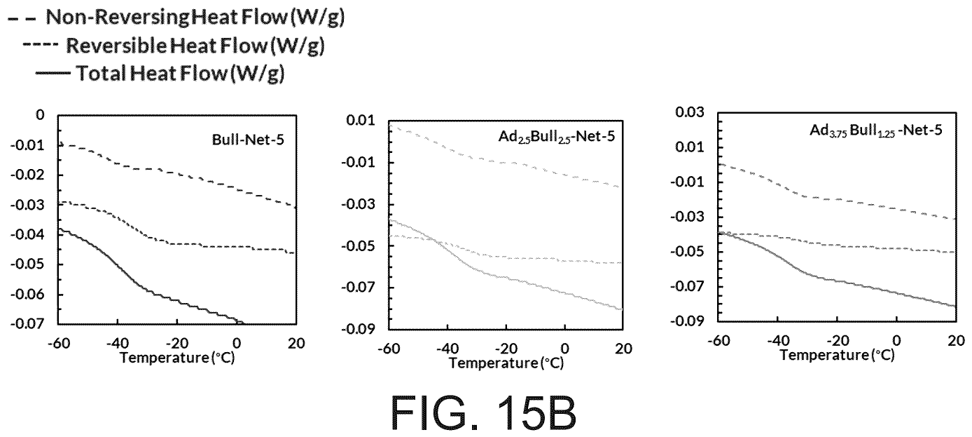

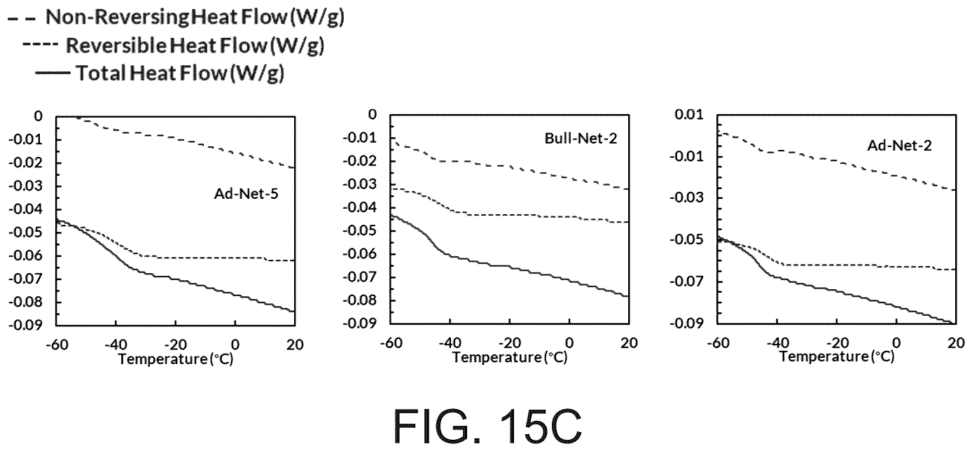

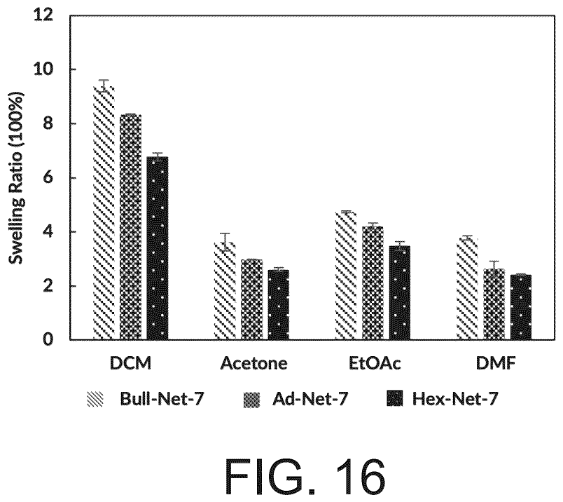

COMPARISON OF PHYSICAL PROPERTIES. The physical properties of the resulting networks (ca. 80% monomer conversion, Table 3) Bull-Net-7, Ad-Net-7, and Hex-Net-7 were characterized using a variety of analytical techniques. Thermal gravimetric analysis (TGA, FIG. 12) confirms that all materials have similar decomposition temperatures (T_{d}=364-377° C.) and helium pycnometry demonstrates that all materials have the same densities (ρ=1.06-1.09 g/cm3, Table 4) at 25° C. To further interrogate network structure, small angle X-ray scattering (SAXS) was performed on Bull-Net-7 and Ad-Net-7 (FIG. S3). Both samples have relatively featureless SAXS curves indicative of no long-range order; a lack of sharp features indicate a lack of crystalline and/or highly-ordered do-mains. Tensile plateau moduli (E′₀) measured using DMA frequency sweep experiments at 20° C. confirm that all materials have E′₀ (0.261, 0.269, 0.405 MPa for Bull-Net-7, Ad-Net-7, Hex-Net-7, respectively) on the same order of magnitude (FIG. S4). These data suggest that Bull-Net-7 and Ad-Net-7 have similar entanglement molecular weights while Hex-Net-7 has shorter distances between crosslinks. The glass transition temperatures of these materials were also characterized through modulated differential scanning calorimetry (MDSC). Analysis of the total heat flow shows that Bull-Net-7 and Ad-Net-7 have similar T_{g,DSC} (−34° C. and −37° C., respectively) (FIG. 4A), while Hex-Net-7 has a lower T_{g,DSC} (−42° C.), likely due to reduced crosslinker rigidity and/or increased crosslinker density.⁶⁸ For the less densely crosslinked materials (X-Net-5 and X-Net-2), adamantane, bullvalene, and “mixed” networks' T_{g,DSC} remained similar (FIGS. 4B and 4C, FIGS. 15A-15C). Swelling experiments were also performed in several organic solvents (methylene chloride, acetone, ethyl acetate, dimethylformamide) to compare crosslinking densities across all X-Net-7 materials (FIG. 16). While Bull-Net-7 consistently has the highest equilibrium swelling ratios, they are generally within 10-15% that of Ad-Net-7. Crosslinker fluxionality (i.e., flexibility) may play a role in facilitating increased swelling for Bull-Net-7. On the other hand, Hex-Net-7 always has a much lower swelling ratio than Bull-Net-7 in all solvents; these inconsistencies in swelling ratios can be attributed potentially to differences in cross-linking sterics and density. Due to the general similarities in monomer conversion, T_{d}, ρ, SAXS, T_{g,DSC}, E′₀, and swelling between Bull-Net-7 and Ad-Net-7, it can be assumed that network structures are comparable for the purposes of subsequent thermomechanical analyses. On the other hand, the comparative differences noted above for Hex-Net-7 suggest that its network structure is not comparable and therefore serves as a negative control for subsequent studies.

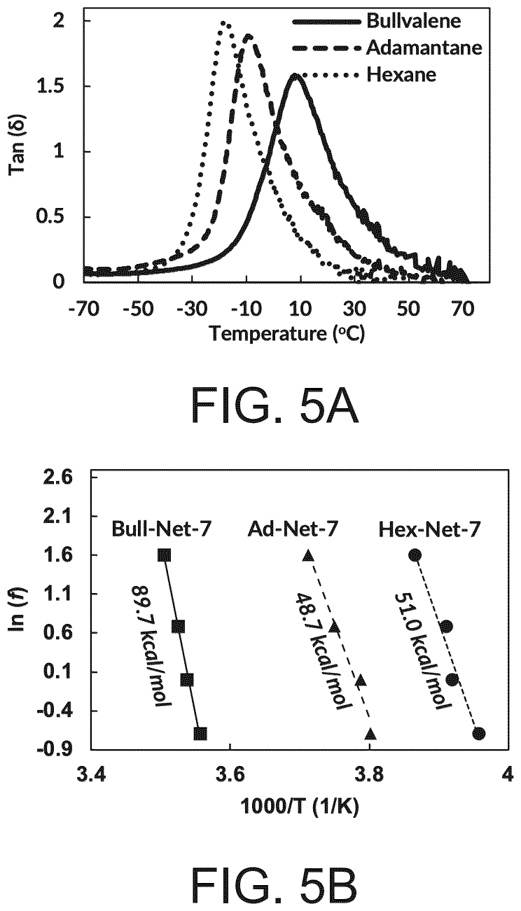

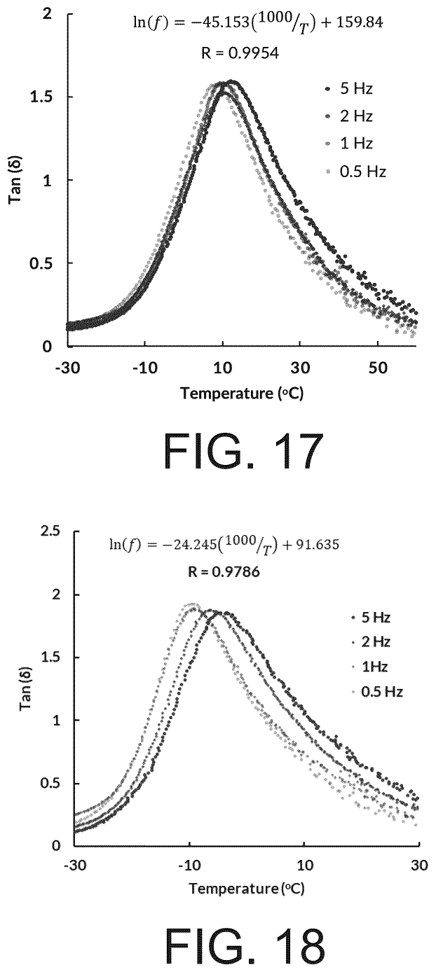

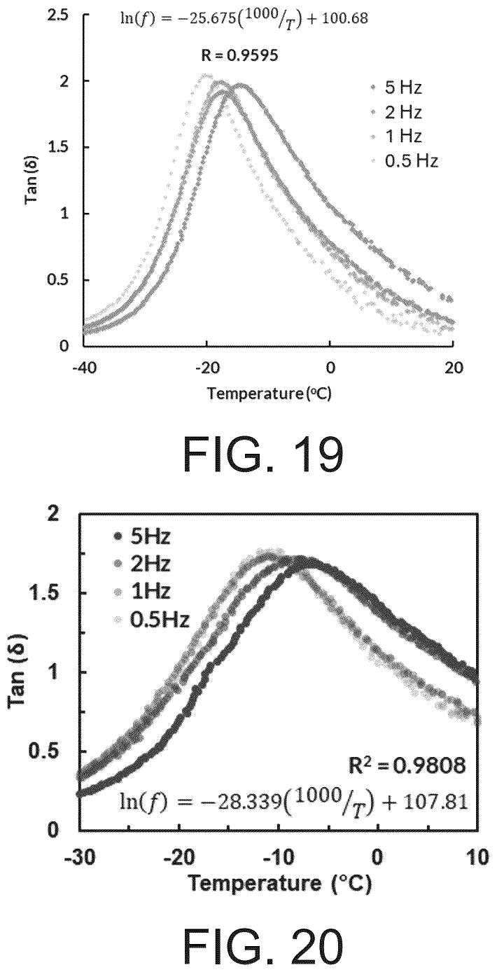

THERMOMECHANICAL ANALYSIS. With an enhanced understanding of X-Net-Y physical and thermal behaviors, thermomechanical analysis was performed next. First, DMA temperature sweep experiments were performed in the linear viscoelastic region under tension (1 Hz); thermomechanical T_{g,DMA} of Bull-Net-7, Ad-Net-7, and Hex-Net-7 were measured to be 4.6° C., −9.1° C. and −18° C., respectively (FIG. 5A), at the apex of each Tan (δ) peak. Bull-Net-7 has the broadest Tan (δ) peak which suggests a more complex damping mechanism (vide infra) relative to Ad-Net-7 and Hex-Net-7. It should be noted that while the span of T_{g,DMA} values is larger than for T_{g,DSC}, the onset of T_{g,DMA} is quite similar across all materials. To quantify differences in these thermomechanical glass transition processes, the respective activation energies were calculated through multi-frequency temperature sweep experiments and fitting to the Arrhenius equation (FIG. 5B, FIGS. 17-19).⁶⁹ Here, Eₐ for Bull-Net-7 T_{g,DMA} transition (89.7 kcal/mol) is significantly higher than for Ad-Net-7 (48.2 kcal/mol) and Hex-Net-7 (51.0 kcal/mol). This broader Tan (δ) peak and elevated Eₐ for Bull-Net-7 could be caused by an increase in fluxional rearrangements as the material approaches the glass transition temperature. As described in more detail below (see Computational Mechanistic Investigations), at lower temperatures under tension, Hardy-Cope fluxionality may exist as a combination of mechanically-guided thermal rearrangements (i.e., slowly-interconverting bullvalenes “align” to the force vector) and/or mechanically-activated rearrangements (i.e., discrete bullvalene isomers function as force-driven mechanophores).⁷⁰ These are not exhaustive options but rather serve as two plausible pathways that are conceptually related to STMBJ-driven bullvalene isomerization reported by Darwish and Fallon.⁶²

In the case of a broader Tan (δ) peak, the exact rearrangement pathway traversed by a particular bullvalene crosslinker likely varies across the continuum of the material due to local network inhomogeneities and/or cooperativity from neighboring bullvalene moieties. In other words, Bull-Net-7 exhibits a wide range of molecular motion stemming from an ensemble of bullvalene rearrangements; the corresponding T_{g,DMA} transition therefore occurs over a broader range of temperatures compared to Ad-Net-7 and Hex-Net-7. In the case of Bull-Net-7's elevated Eₐ for the T_{g,DMA} transition, long range segmental motion is restricted below T_{g,DMA} and bullvalene has access to only a few immediate isomers that do not bring structural changes to the polymer network. As the temperature continues to rise while approaching T_{g,DMA}, molecular mobility dramatically increases. Consequently, there are more degrees of freedom for bullvalene to access additional isomers while adapting to the external force vector through a series of Hardy-Cope rearrangements. In doing so, energy is dissipated within the bullvalene cage (i.e., additional energy is required for sigmatropic rearrangements) and the observed Eₐ for Bull-Net-7 is elevated relative to those of the control networks.

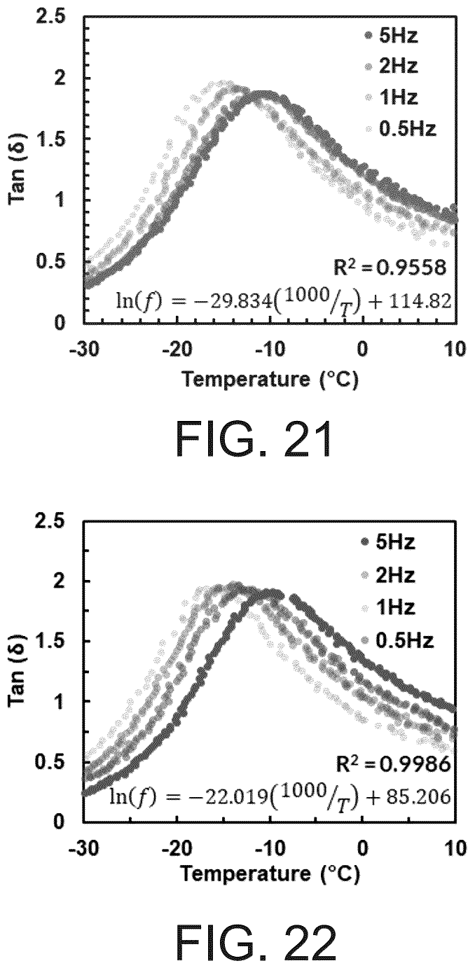

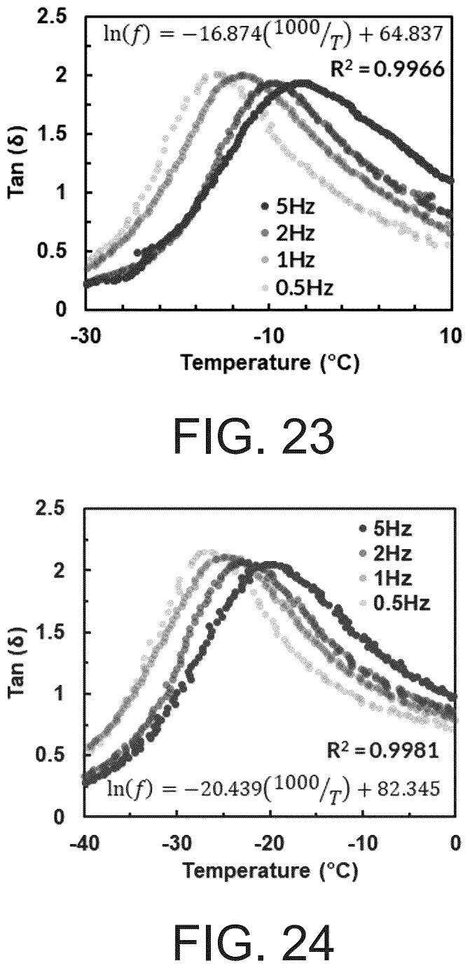

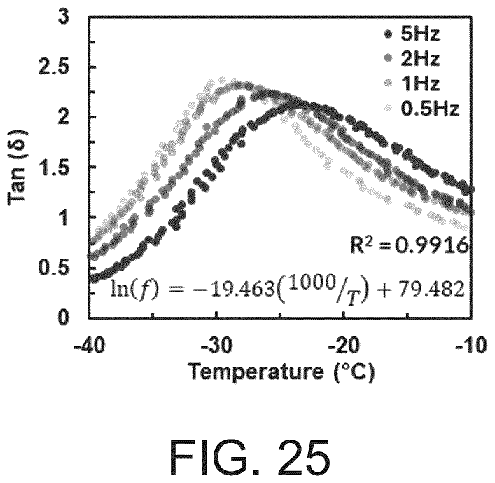

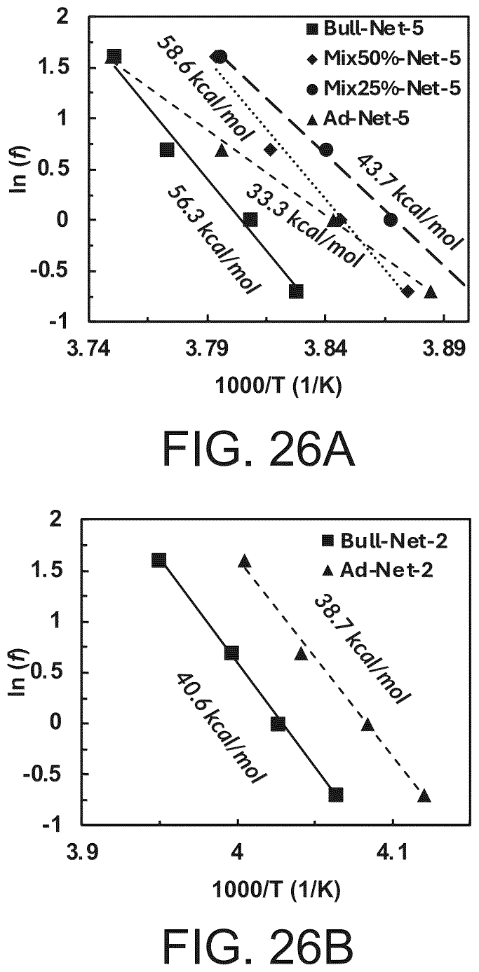

Despite Ad-Net-7 acting as a “similar” net-work and Hex-Net-7 acting as “dissimilar” network relative to Bull-Net-7, Bull-Net-7 retains the broadest Tan (δ) peak and highest Eₐ for T_{g,DMA} transition across all three materials. In fact, these trends hold true for bullvalene-containing X-Net-5 materials as well (Table 1 and FIGS. 20-26), suggesting that crosslinker identity rather than net-work structure is a driver in these phenomena. At lower crosslinker loadings (i.e., Bull-Net-2 and Ad-Net-2), minimal difference is observed in temperature-sweep experiments as longer distances between crosslinks dilute the impacts of bullvalene described above.

TABLE 1
Summary of X-Net-Y Temperature-Sweep Experiments

| | | Eₐ of T_{g} Transition |
|---|---|---|
| Sample | T_{g, DMA} (° C.)^{a} | (kcal/mol)^{b} |
| Bull-Net-7 | 4.6 | 89 |
| Ad-Net-7 | −9.1 | 48 |
| Hex-Net-7 | −18 | 51 |
| Bull-Net-5 | −11 | 56 |
| Bull_{2.5}Ad_{2.5}-Net-5 | −14 | 59 |
| Bull_{1.25}Ad_{3.75}-Net-5 | −15 | 44 |
| Ad-Net-5 | −13 | 34 |
| Bull-Net-2 | −25 | 41 |
| Ad-Net-2 | −28 | 39 |

^{a}Reported from apex of Tan (δ) peak (1 Hz).
^{b}Calculated from an Arrhenius fit of multi-frequency (5 Hz, 2 Hz, 1 Hz, 0.5 Hz) temperature-sweep experiments.

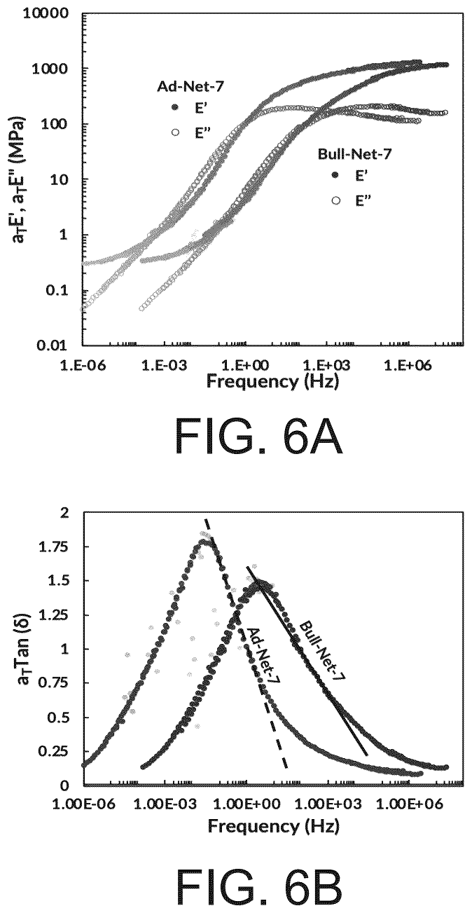

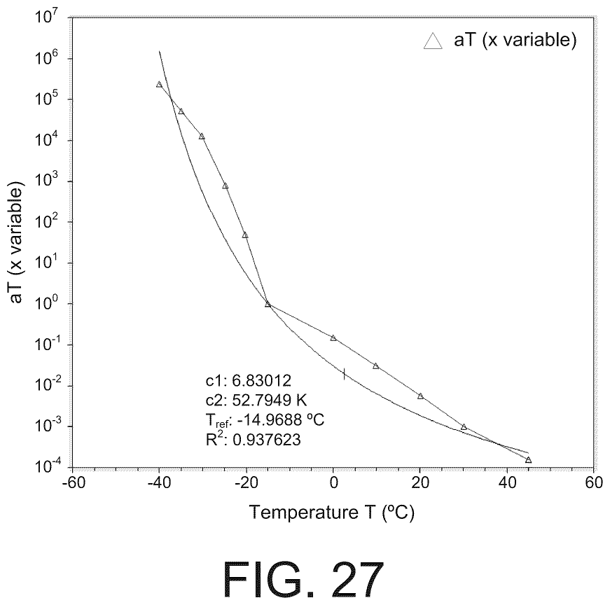

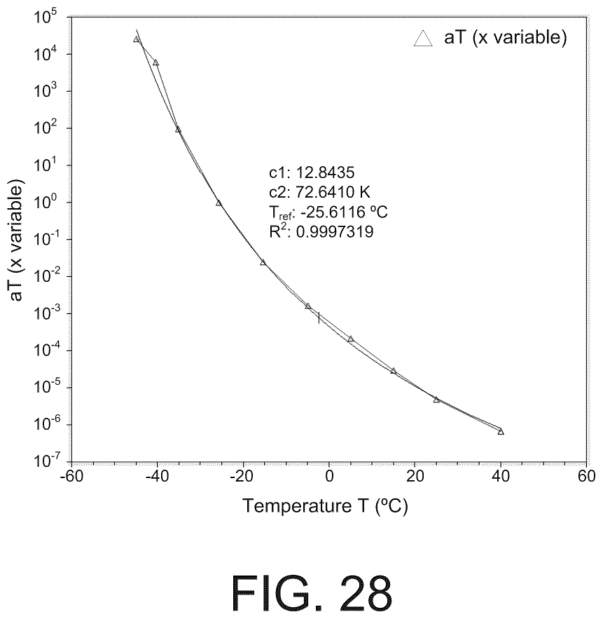

Ad-Net-7 and Bull-Net-7 were then subjected to frequency sweep experiments using DMA. In these experiments, thermomechanical behavior was studied across a range of temperatures and frequencies (1 Hz-100 Hz). Master curves were then generated for each of the two networks spanning many decades of frequency using the principle of time-temperature superposition (FIGS. 6A-6B, FIGS. 27, 28). Master curves were generated by using appropriate shift factors with T_{ref}=T_{g,DMA}−20° C. While the master curves are generally comparable between Ad-Net-7 and Bull-Net-7, further supporting the assumption that these two thermosets have similar network structures, there is an interesting difference worth pointing out. The onset of the glassy region is more gradual near the edge of the glass transition region (higher frequency/lower temperature) in the case of Bull-Net-7 compared to Ad-Net-7. In other words, E′ and E″ level off more rapidly than what is observed for Bull-Net-7 (FIG. 6A). As a result, the corresponding Tan (δ) curve (FIG. 6B) for Bull-Net-7 is broader than that of Ad-Net-7, akin to what was observed in the temperature-sweep experiments (FIG. 5A). In addition, this broadening observed in the Bull-Net-7 Tan (δ) curve is unsymmetrical; the curve tails significantly into the higher frequency/lower temperature region because of the more gradual onset of the glassy region as reflected in E′ and E″ values. At higher temperatures well above T_{g,DMA}, it is known that bullvalene remains fluxional. When bullvalene is dynamic, it can rapidly sample an ensemble of valence isomers and molecular motion is rapid. The rapid bullvalene fluxionality alongside freedom in molecular and chain mobility renders Bull-Net-7 similar to Ad-Net-7 at lower frequency/higher temperature. Previous work studying bullvalene thermoplastics supports operative Hardy-Cope rearrangements throughout the polymer backbone as evidenced by enhanced thermal stability relative to unsaturated analogs.⁶³ As the temperature decreases and approaches T_{g,DMA}, macromolecular motion is limited and bullvalene rearrangements slow down; some bullvalenes may even be kinetically trapped as static valence isomers. As energy is applied through oscillatory tension in frequency sweep experiments, bullvalene may rearrange to applied mechanical force (vide infra) by absorbing energy and guiding these rearrangements along the way. As a result, the broadening of the Bull-Net-7 Tan (δ) curve and asymmetry at higher frequencies/lower temperatures is the consequence of less thermally active bullvalenes. The result is an ensemble of damping pathways, potentially involving disparate mechanically-guided and/or mechanically-activated Hardy-Cope rearrangements across a broad range of temperatures.

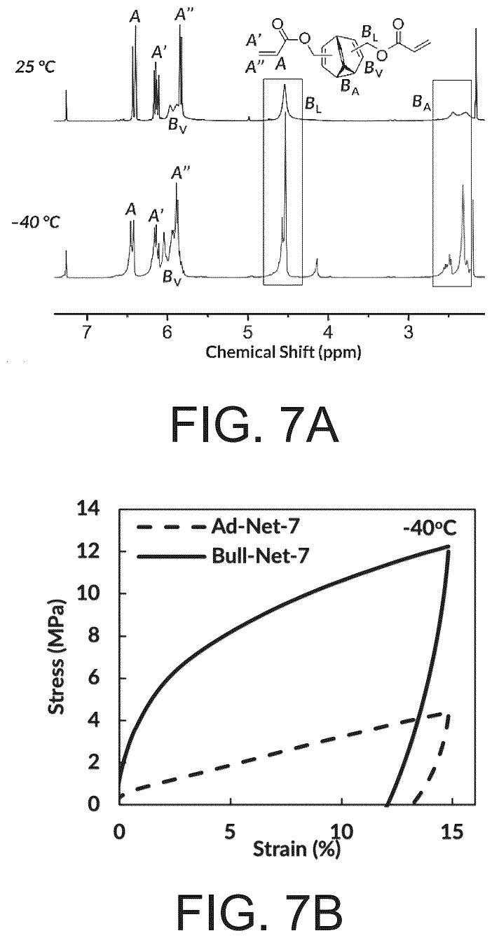

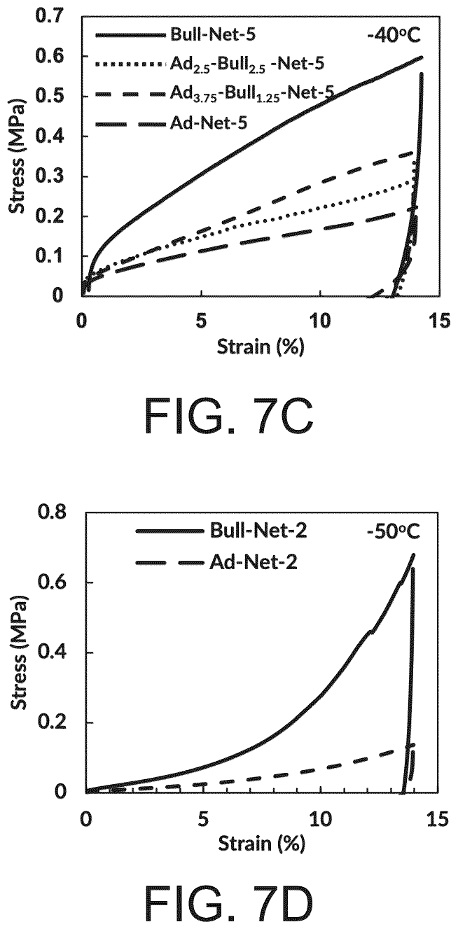

TENSILE EXPERIMENTS. To glean insight to potential temperature-dependent phenomena in Bull-Net-X, solution-state variable temperature NMR (VT-NMR) experiments (FIG. 7A) were conducted on Bull-DA that reveals slow chemical exchange at 25° C. consistent with Eₐ=ca. 11 kcal/mol; broad bullvalene vinyl proton (BV), alkyl proton (BA) and methylene linker proton (BL) resonances around 5.9 ppm, 2.3 ppm, and 4.5 ppm, respectively support this claim. When Bull-DA is cooled to −40° C., BV, BA and BL resonances sharpen as the rate of chemical exchange via thermal Hardy-Cope rearrangements decreases further and approach a static structure. Meanwhile, proton resonances not directly connected to the bullvalene cage (A, A′, A″) actually broaden as bond rotation (Eₐ<3 kcal/mol) slows on the NMR timescale. The differing dynamics between the chemical (i.e., bullvalene Hardy-Cope rearrangements) and physical (i.e., bond rotations) allows us to tame bullvalene fluxionality at lower temperatures, rendering bullvalene nearly static and confining it to a smaller quantity of valence isomers. In fact, these observations align well with the unique low temperature behavior observed in Bull-Net-Y compared to Ad-Net-Y (vide supra). Thus, in order to probe mechanochemical perturbation and/or activation of Hardy-Cope rearrangements in bulk materials outside the linear viscoelastic region under tension, it was reasoned that experiments needed to be conducted at lower temperatures where thermal bullvalene fluxionality becomes suppressed.

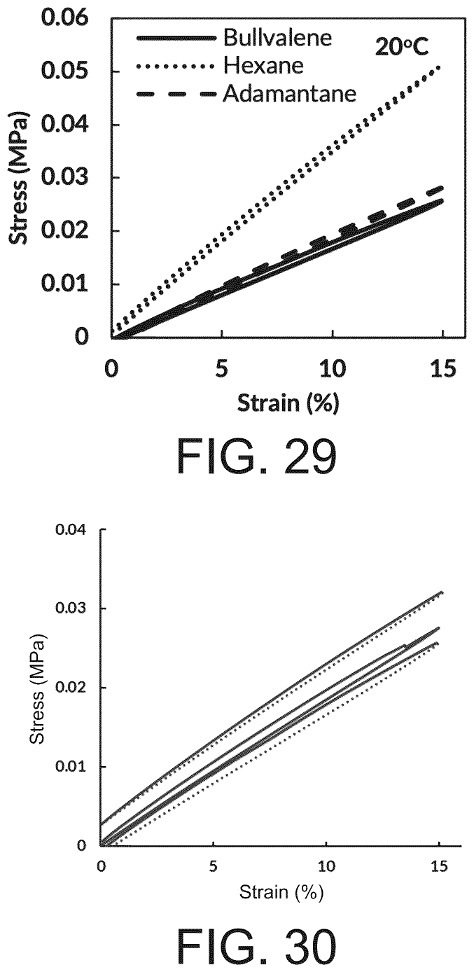

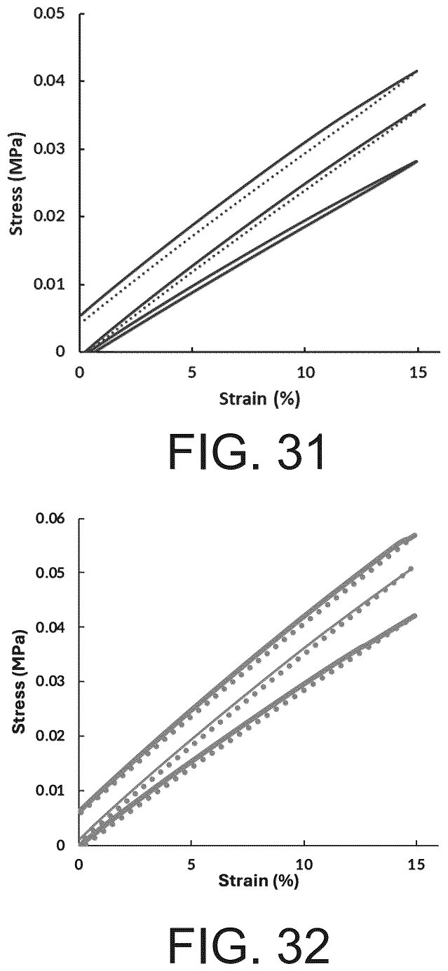

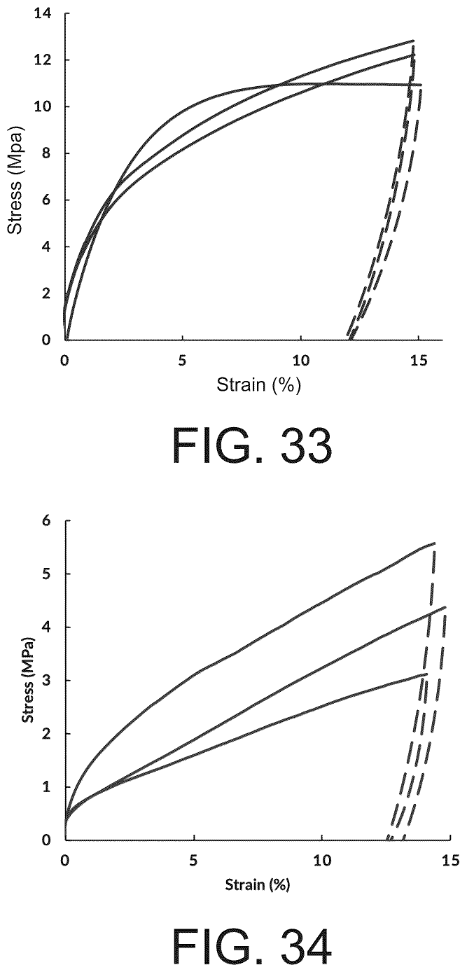

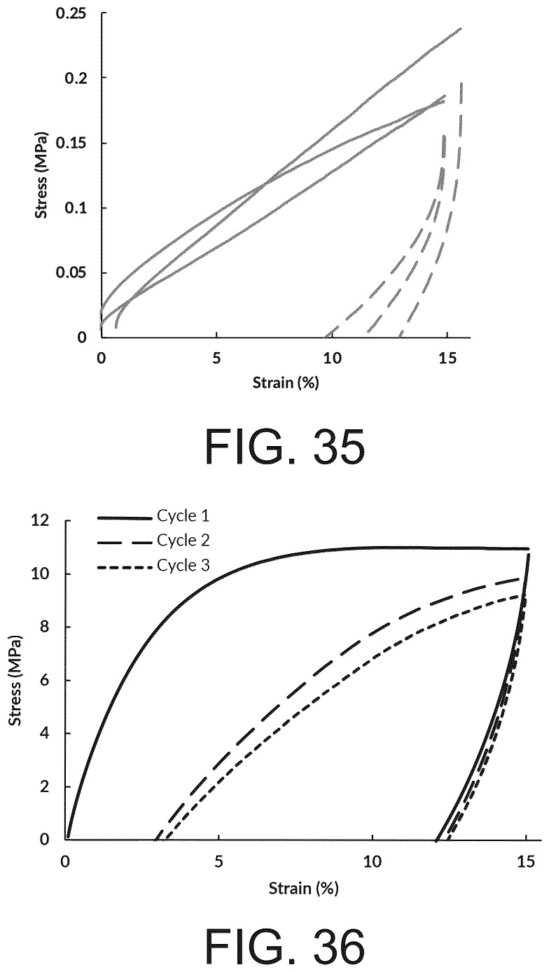

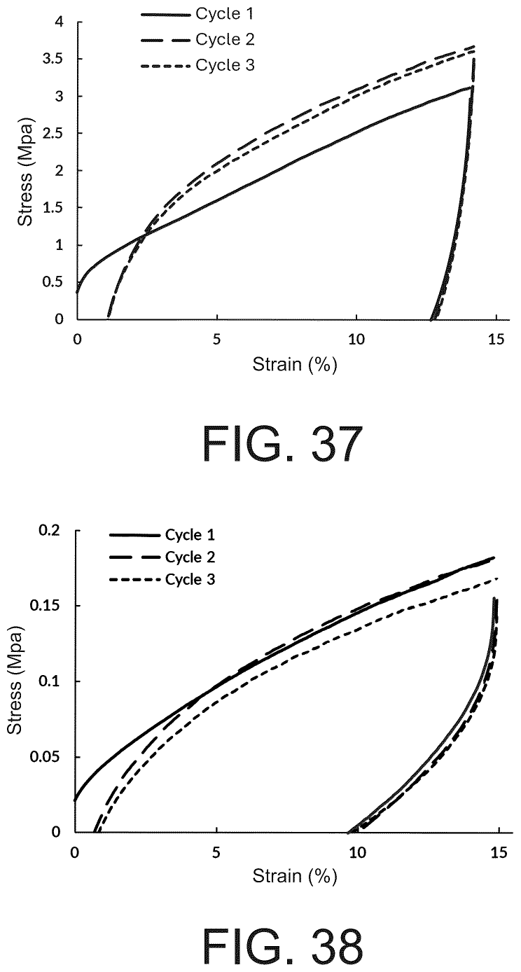

Examination of X-Net-7 bulk energy dissipation behavior was carried out using DMA via cyclic loading experiments. At 20° C., Bull-Net-7, as well as control network Ad-Net-7, display minimal hysteresis (FIGS. 29-32). Bull-Net-7 and Ad-Net-7 also have similar Young's moduli (E=ca. 0.0022 MPa, Table 5). When the same cyclic loading experiments were carried out at −40° C. (FIG. 7B, FIGS. 33-38), all materials display strain-stress curves known for glassy polymer with little immediate recovery upon unloading.^{71.72} While Ad-Net-7 has noticeable energy dissipation characteristics (EH=2110 J/m2), Bull-Net-7 has nearly three-times the hysteresis energy of Ad-Net-7 (EH=6240 J/m2) with enhanced stiffening (E=8.5 MPa, Table 6).

It should be noted that the mechanism of deformation in materials below glass transition is different from conventional viscoelastic behavior above T_{g}. Instead of long-range disentanglement through chain sliding, bond cleavage and local molecular motion generally dominate.^{68,71,72} Repeated cyclic loading of all X-Net-7 materials at −40° C. does not show loss in mechanical performance, thus confirming that minimal covalent bond cleavage occurs at low temperature in X-Net-7 materials.

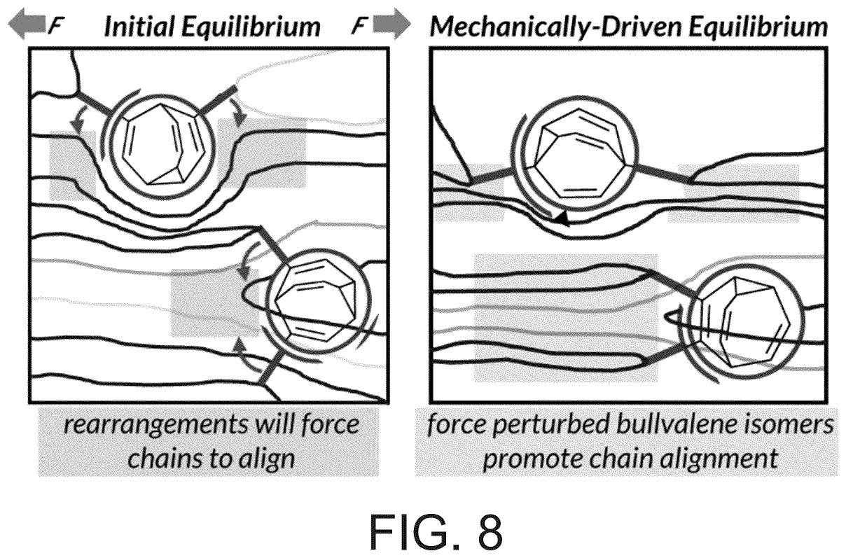

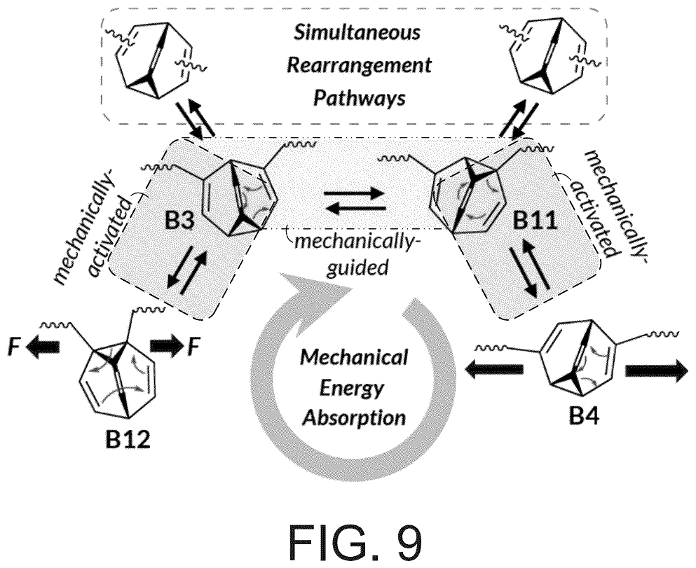

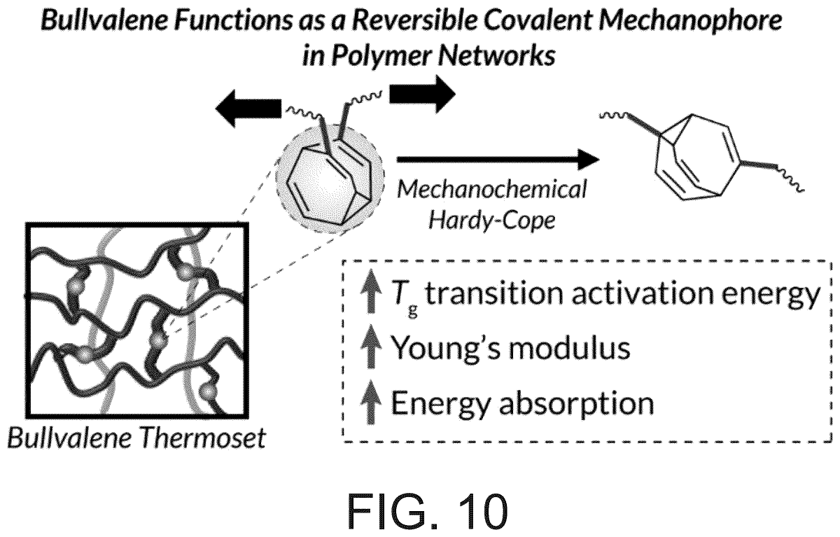

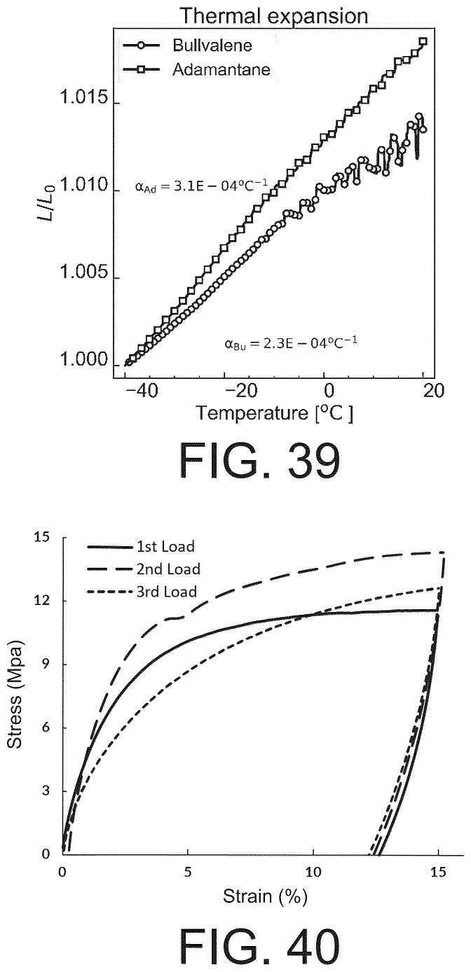

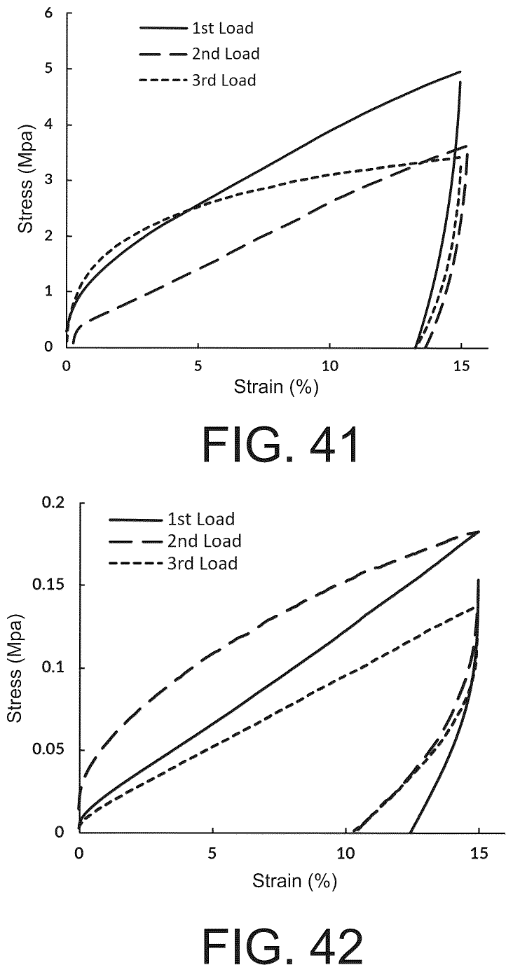

To confirm that this behavior (FIGS. 7A-7D) is not due to variations in material density below T_{g,DMA}, thermal expansion experiments were performed at −40° C. (FIG. 39). As no significant differences were observed between Bull-Net-7 and Ad-Net-7, corroboration with pycnometry data (Table 4) implies comparable low temperature densities. The observed differences in hysteresis energies may be attributed to differences in the relative stiffness and yield stress of these materials. For example, Bull-Net-7 has a much higher Young's modulus (E=8.5 MPa) relative to Ad-Net-7 (E=3.8 MPa). Unlike sterically demanding adamantane, similarly sized bullvalene rearranges upon applied mechanical force, (i.e., “molecular ball joint”) to further realign the already packed polymer strands together and make the material stiffer (FIG. 8). In other words, as the rate of bullvalene Hardy-Cope rearrangements de-crease at the lower experimental temperature, there is an opportunity to guide the valence isomer trajectory and/or activate certain isomers with external mechanical force. Additionally, without free segmental motion, the initial input mechanical energy can be first “absorbed” in Bull-Net-7 by bullvalene rearrangements and the subsequent realignment of polymer chains. The result is that Bull-Net-7 has a much higher yield stress (ca. 6 MPa at ca. 2% strain) compared to Ad-Net-7 (yield stress <1 MPa at <1% strain) in the shear yielding process.^{71,72} In other words, at low temperatures Bull-Net-7 has increased stiffness and yield stress relative to control networks; these properties contribute to a sigmatropic rearrangement driven high hysteresis energy for Bull-Net-7. These phenomena are not limited to X-Net-7; analogous Ad-Net-Y and Bull-Net-Y with lower cross-linker loading (Y=2 or 5 mol %) show similar trends in tensile properties (FIG. 7C-7D, Table 2). The same “mixed” systems previously used to study T_{g,DMA} (Table 1) were also tested and it was found that Bull_{2.5}Ad_{2.5}-Net-5 and Bull_{1.25}Ad_{3.75}-Net-5 have intermediary E and EH relative to Bull-Net-5 and Ad-Net-5; these data further support the conclusion that bullvalene incorporation enhances mechanical properties. Furthermore, these processes were all demonstrated to be fully reversible; when X-Net-7 materials are allowed to warm to room temperature between successive loading at −40° C. minimal changes in the resulting stress-strain curves are observed (FIGS. 40-42).

TABLE 2
Summary of X-Net-Y Tensile Results

| | Young's Modulus, | Hysteresis Energy, |
|---|---|---|
| Sample | E (MPa) | E_{H} (KJ/m²) |
| Bull-Net-7^{a} | 8.50 | 6.24 |
| Ad-Net-7^{a} | 3.80 | 2.11 |
| Hex-Net-7^{a} | 0.110 | 0.805 |
| Bull-Net-5^{a} | 1.00 | 0.226 |
| Bull_{2.5}Ad_{2.5}-Net-5^{a} | 0.640 | 0.198 |
| Bull_{1.25}Ad_{3.75}-Net-5^{a} | 0.680 | 0.141 |
| Ad-Net-5^{a} | 0.600 | 0.0979 |
| Bull-Net-2^{b} | 0.810 | 0.124 |
| Ad-Net-2^{b} | 0.029 | 0.0301 |

^{a}Data collected at −40° C.
^{b}Data collected at −50° C.

CONCLUSION. In summary, the present disclosure reports the utility of low barrier Hardy-Cope rearrangements under strain in polymer networks by incorporating fluxional bullvalenes into n-butyl acrylate-based thermoset elastomers. DMA temperature sweep experiments quantitatively demonstrate that bullvalene can dissipate energy more effectively than “static” controls, thereby increasing the activation energy for the glass transition process. While thermomechanical testing supports similar behavior between bullvalene (Bull-Net-Y) and adamantane (Ad-Net-Y) crosslinked materials at room temperature, as the rate of bullvalene Hardy-Cope rearrangements decrease at lower temperature, frequency sweep experiments suggest rearrangements can be activated mechanochemically. Cyclic loading experiments at temperatures below T_{g,DMA} demonstrate that Bull-Net-Y is much stiffer with high hysteresis energy. Comparisons against Ad-Net-7 suggests bullvalene's ability to rearrange upon applied mechanical force facilities chain alignment and stiffens the material upon loading. Finally, CoGEF simulations are employed to demonstrate the stability of the bullvalene cage under external mechanical force while also revealing two “mechanically competent” valence isomers capable of engaging in mechanically-activated Hardy-Cope rearrangements. Overall, having a unimolecular “ball joint” moiety that can dissipate energy through reversible sigmatropic rearrangements shows great potential for enhancing the durability of existing thermo-sets and opens new opportunities for impact and vibration resistant materials.

### REFERENCES FOR EXAMPLE 1

(1) Willis-Fox, N. et al., Chem 2018, 4 (11), 2499-2537.
(2) Ghanem, M. A. et al., Nat. Rev. Mater. 2021, 6 (1), 84-98.
(3) Küng, R. et al., Chem.-Eur. J. 2022, 28 (17), e202103860.
(4) Larsen, M. B. et al., J. Am. Chem. Soc. 2013, 135 (22), 8189-8192.
(5) Zeng, T. et al., J. Am. Chem. Soc. 2024, 146 (1), 95-100.
(6) Davis, D. A. et al., Nature 2009, 459 (7243), 68-72.
(7) Ducrot, E. et al., Science 2014, 344 (6180), 186-189.
(8) Sagara, Y. et al., J. Am. Chem. Soc. 2021, 143 (14), 5519-5525.
(9) Sivakova, S. et al., Chem. Soc. Rev. 2005, 34 (1), 9-21.
(10) Voorhaar, L. et al., Soc. Rev. 2016, 45 (14), 4013-4031.
(11) Xia, D. et al., Chem. Rev. 2020, 120 (13), 6070-6123.
(12) Zhu, Y. et al., Chem. Soc. Rev. 2021, 50 (13), 7395-7417.
(13) Zheng, B. et al., Chem Soc Rev 2012, 41 (5), 1621-1636.
(14) Smith, P. T. et al., Biomacromolecules 2020, 21 (2), 484-492.
(15) K. Andrew Miller et al., Chem. Commun. 2022, 58 (37), 5590-5593.
(16) Traeger, H. et al., Polym. Chem. 2022, 13 (19), 2860-2869.
(17) Burattini, S. et al., J. Am. Chem. Soc. 2010, 132 (34), 12051-12058.
(18) Wang, F. et al., Angew. Chem. Int. Ed. 2023, 62 (36), e202305827.
(19) Chen, L. et al., J. Am. Chem. Soc. 2024, 146 (1), 1109-1121.
(20) Song, Y. et al., Angew. Chem. Int. Ed. 2018, 57 (42), 13838-13842.
(21) Xing, P. et al., J. Am. Chem. Soc. 2019, 141 (25), 9946-9954.
(22) Zhang, Q. et al., J. Am. Chem. Soc. 2019, 141 (20), 8058-8063.
(23) Scherman, O. A. et al., Proc. Natl. Acad. Sci. 2006, 103 (32), 11850-11855.
(24) Cordier, P. et al., Nature 2008, 451 (7181), 977-980.
(25) Sijbesma, R. P. et al., Science 1997, 278 (5343), 1601-1604.
(26) Diao, K. et al., Chem. Commun. 2022, 58 (14), 2343-2346.
(27) Zhukhovitskiy, A. V. et al., Nat. Chem. 2016, 8 (1), 33-41.
(28) McConnell, A. J. et al., Chem. Rev. 2015, 115 (15), 7729-7793.
(29) Yount, W. C. et al., J. Am. Chem. Soc. 2005, 127 (41), 14488-14496.
(30) Beck, J. B. et al., J. Am. Chem. Soc. 2003, 125 (46), 13922-13923.
(31) Hailes, R. L. N. et al., Chem. Soc. Rev. 2016, 45 (19), 5358-5407.
(32) Okumura, Y. et al., Adv. Mater. 2001, 13 (7), 485-487.
(33) Jiang, L. et al., Chem. Mater. 2018, 30 (15), 5013-5019.
(34) Noda, Y. et al., J. Appl. Polym. Sci. 2014, 131 (15).
(35) Liu, C. et al., Science 2021, 372 (6546), 1078-1081.
(36) Ito, K., Polym. J. 2007, 39 (6), 489-499.
(37) Zhao, J. et al., J. Am. Chem. Soc. 2022, 144 (2), 872-882.
(38) Hart, L. F. et al., J. Am. Chem. Soc. 2023, 145 (22), 12315-12323.
(39) Yang, X. et al., Nat. Commun. 2022, 13 (1), 6654.
(40) Nosiglia, M. A. et al., J. Am. Chem. Soc. 2022, 144 (22), 9990-9996.
(41) Chen, X. et al., Science 2002, 295 (5560), 1698-1702.
(42) Stevenson, R. et al., J. Am. Chem. Soc. 2017, 139 (46), 16768-16771.
(43) Bailey, S. J. et al., Mater. Horiz. 2022, 9 (7), 1947-1953.
(44) Wang, S. et al., J. Am. Chem. Soc. 2021, 143 (10), 3714-3718.
(45) Wang, Z. et al., Science 2021, 374 (6564), 193-196.
(46) Wang, S. et al., Science 2023, 380 (6651), 1248-1252.
(47) von E. Doering, W. et al., Tetrahedron 1963, 19 (5), 715-737.
(48) Schröder, G., Angew. Chem. Int. Ed. Engl. 1963, 2 (8), 481-482.
(49) Cope, A. C.; Hardy, E. M., J. Am. Chem. Soc. 1940, 62 (2), 441-444.
(50) Bismillah, A. N. et al., Chem. Sci. 2020, 11 (2), 324-332.
(51) Ferrer, S. et al., Synthesis 2019, 51 (5), 1037-1048.
(52) Birvé, A. P. et al., Angew. Chem. Int. Ed. 2022, 61 (9), e202115468.
(53) Bismillah, A. N. et al., Chem. Sci. 2018, 9 (46), 8631-8636.
(54) Dohmen, C. et al., Chem.-Eur. J. n/a (n/a), e202304311.
(55) Schröder, G. et al., Angew. Chem. Int. Ed. Engl. 1979, 18 (4), 311-312.
(56) Teichert, J. F. et al., J. Am. Chem. Soc. 2013, 135 (30), 11314-11321.
(57) Ferrer, S. et al., Angew. Chem. Int. Ed. 2016, 55 (37), 11178-11182.
(58) Yahiaoui, O. et al., Angew. Chem. Int. Ed. 2018, 57 (10), 2570-2574.
(59) Patel, H. D. et al., J. Am. Chem. Soc. 2020, 142 (8), 3680-3685.
(60) Müller, A. et al., Mol. Phys. 1994, 81 (5), 1239-1258.
(61) Meier, B. H. et al., J. Am. Chem. Soc. 1985, 107 (19), 5553-5555.
(62) Reimers, J. R. et al., Nat. Commun. 2023, 14 (1), 6089.
(63) Pomfret, M. N. et al., Angew. Chem. Int. Ed. 2023, 62 (19), e202301695.
(64) Achard, M. et al., J. Org. Chem. 2006, 71 (7), 2907-2910.
(65) Zimmerman, H. E. et al., J. Am. Chem. Soc. 1969, 91 (7), 1718-1727.
(66) Zimmerman, H. E. et al., J. Am. Chem. Soc. 1966, 88 (1), 183-184.
(67) Zimmerman, H. E. et al., J. Am. Chem. Soc. 1967, 89 (15), 3932-3933.
(68) Hiemenz, P. C. et al., Polymer Chemistry, 2nd ed.; CRC Press: Boca Raton, 2007.
(69) Li, G. et al., J. Therm. Anal. calorim. 2000, 60 (2), 377-390.
(70) Izak-Nau, E. et al., Polym. Chem. 2020, 11 (13), 2274-2299.
(71) The Physics of Glassy Polymers, 2. ed.; Haward, R. N., Haward, R. N., Eds.; Chapman & Hall: London, 1997.
(72) Kausch, H. H. et al., Science 1973, 181 (4103), 961-962.
(73) Beyer, M. K., J. Chem. Phys. 2000, 112 (17), 7307-7312.
(74) Klein, I. M. et al., J. Am. Chem. Soc. 2020, 142 (38), 16364-16381.
(75) Wick, C. R. et al., Forces Mech. 2022, 9, 100143.

### Supporting Information for Experimental Example 1

### General Considerations:

MATERIALS. All reagents were purchased from commercial suppliers and used as received unless otherwise noted. Glassware was flame dried or dried in an oven overnight at 120° C. before use. Degassed and anhydrous tetrahydrofuran (THF) and dichloromethane (DCM) were obtained from a JC Meyer solvent purification system. All moisture and air-sensitive reactions were performed under inert atmosphere (nitrogen) using standard Schlenk technique. SiliaFlash F60 (40-63 μm, 230-400 mesh) silica gel was used for column chromatography. Photochemistry was performed using an EvoluChem PhotoRedOx Box (HepatoChem) with 365 nm LEDs.

CHARACTERIZATION ¹H nuclear magnetic resonance (¹H NMR) and ¹³C nuclear magnetic resonance (¹³C NMR) spectra were obtained on a Bruker AVANCE-300, Bruker AVANCE-500, or Bruker DRX-500 NMR spectrometer. Variable temperature (VT) ¹H and ¹³C NMR NMR spectra were taken on a Bruker AVANCE-500 NMR spectrometer. 1H NMR spectra were taken in chloroform-d (CDCl3, referenced to TMS, δ 0.00 ppm) and DMSO-d6 ((CD3)2SO, referenced to residual (CH3)2SO, δ 2.54 ppm). All 13C NMR spectra were taken in chloroform-d (referenced to chloroform, δ 77.16 ppm). Spectra were analyzed on MestreNova software. Chemical shifts are represented in parts per million (ppm); splitting patterns are assigned as s (singlet), d (doublet), t (triplet), q (quartet), p (quintet), m (multiplet), and br (broad); coupling constants, J, are reported in hertz (Hz).

High resolution electron spray ionization mass spectrometry (ESI-MS) experiments were done using a Thermo LTQ Orbitrap mass spectrometer.

Equilibrium swelling tests were performed by soaking ca. 20 mg of final X-Net-7 material in 10 mL of designated solvent, then monitoring the material's mass until no further swelling occurred. The swelling ratios were calculated with the following Equation 1:

$$Swelling Ratio = \frac{{W}_{s} - {W}_{i}}{{W}_{i}} \times 100 \% \qquad ( 1 )$$

where Wₛ represents the mass of swollen sample and Wᵢ is the initial mass of the sample.

Density (ρ) was determined at 25° C. by employing an Anton Paar Ultra5000 gas pycnometer using UHP He gas. The thermal expansion coefficients were determined by an RSA-G2 dynamic mechanical analyzer (TA Instruments) equipped with Forced Convection Oven. A constant force 0.1-0.2 N was maintained using the iso-force mode and the length (L) change with temperature (T) was recorded as the temperature was cooled from 25° C. to −50° C. at a rate of 2° C./min.¹ The linear thermal expansion coefficients were extracted by linear fitting to ln(L) vs. T from 20° C. to −40° C., see Equation 2:1

$$α = \frac{1}{L} \frac{dL}{dT} = \frac{d ( ln ( L ) )}{dT} \qquad ( 2 )$$

Thermogravimetric analysis (TGA) data was collected using a TA Discovery Q5000 thermogravimetric analyzer. Tests were conducted using ramp rate of 20° C./min starting from operating temperature (ca. 35° C.) to 500° C.

X-ray scattering was measured at room temperature using a Xenocs Xeuss 3.0 (Grenoble, France) small-angle X-ray scattering (SAXS) instrument with a GeniX3D copper radiation source without beam stop. Samples approximately 0.75 mm thick were analyzed at 50, 370, 900, and 1800 mm sample-to-detector distances to cover a q-range of 3.0×10-3 to 3.3×10-1 Å-1. Two spots from each sample were measured at each sample-to-detector distance for 4, 8, 15, and 20 minutes, respectively, and then averaged together. Scattering contribution from the empty beam was collected for 8, 16, 30, and 40 minutes at each sample-to-detector distance, respectively, and subtracted from the sample scattering. Sample data from each distance were subsequently merged and scaled using Xenocs XSACT Software v2.7 (Grenoble, France).

Modulated differential scanning calorimetry (MDSC) data was collected using a TA Discovery DSC 2500. 7.3 mg of each samples were prepared in aluminum hermetic pans purchased from TA Instrument. Tests were conducted using conventional method with a heating rate of 2° C./min with temperature oscillation amplitude of 0.318° C. from −80° C. to 50° C.

Dynamic mechanical analysis (DMA) data was collected using TA Discovery DMA 850 in tensile mode. Samples were clamped onto the tension clamp after instrument equilibrate to set temperature. Samples were then further soaked for 15 minutes at set temperature. All oscillatory tests were conducted within the linear viscoelastic region at set temperature as confirmed through strain sweep experiments. Temperature sweep experiments were conducted from −70° C. to 100° C. at 0.03% strain at 5° C./min ramp rate. Master curves were obtained through frequency sweep experiments at selected temperatures (from −40° C. to 40° C.) from 1 to 100 Hz. Cyclic loading experiments were conducted from 0% to 15% strain at 2% strain/min at 20° C., −40° C. and −50° C.

### Synthetic and Experimental Procedures

### 1. Synthesis of TBS Protected 2-butyn-1,4-diol (2)

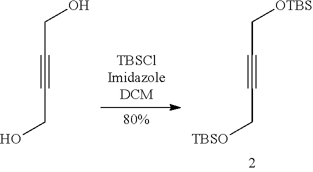 [SMILES: OCC#CCO ; CC(C)(C)[Si](C)(C)OCC#CCO[Si](C)(C)C(C)(C)C]

In a 500 mL round bottom flask, 2-butyn-1,4-diol (10.0 g, 116 mmol, 1.00 eq.), tert-butyldimethylsilyl chloride (38.5 g, 255 mmol, 2.20 eq.) and imidazole (23.7 g, 348 mmol, 3.00 eq.) were added and dissolved in 400 mL of DCM. The suspension was stirred overnight under nitrogen, then washed with 3×100 mL saturated NaHCO₃ solution, 1×100 mL water and 1×100 mL brine. The organic layer was then filtered through a pad of silica and solvents were removed under reduced pressure to afford 2 as a clear liquid (29.2 g, 80%). The material used in subsequent experiments without further purification. ¹H-NMR (500 MHZ, CDCl₃) δ 4.34 (s, 4H), 0.91 (s, 18H), 0.12 (s, 12H).

### 2. Synthesis of CoBr₂(dppe)

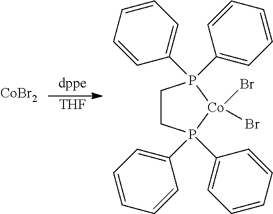

Diphenylphosphinoethane (dppe, 91.0 g, 229 mmol, 1.00 eq.) was added to a 1 L flame dried flask. The flask was then evacuated and refilled with nitrogen three times. Dry THF (50 mL) was added to the reaction flask and stirred until dppe was completely dissolved. Then, CoBr₂ (50.0 g, 229 mmol, 1.00 eq.) was added and the reaction stirred at room temperature under nitrogen. The reaction mixture was filtered under vacuum and the precipitate (catalyst) was dried under vacuum (ca. 100 mTorr) for 6 hours yielding the catalyst as a green powder (140 g, 99%).

### 3. Synthesis of TBS Protected Dimethanol Bicyclo[4.2.2]deca-2,4,7,9-tetraene (3)

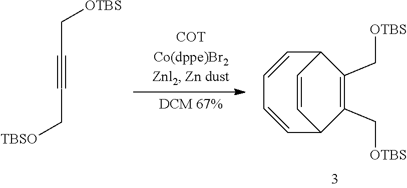 [SMILES: CC(C)(C)[Si](C)(C)OCC#CCO[Si](C)(C)C(C)(C)C ; CC(C)(C)[Si](C)(C)OCC1=C(CO[Si](C)(C)C(C)(C)C)C2C=CC1/C=C\C=C/2]

CoBr₂(dppe) (9.48 g, 15.4 mmol, 0.100 eq.), ZnI₂ (9.81 g, 30.7 mmol, 0.200 eq.), and Zn (3.01 g, 46.1 mmol, 0.300 eq.) were added to a flame dried flask with a magnetic stir bar. The flask containing solids was evacuated and refilled 3 times. Then, 300 mL dry, degassed DCM was added, and the mixture stirred for 15 minutes under nitrogen. Cyclooctatetraene (17.3 mL, 154 mmol, 1.00 eq.) and TBS protected 2-butyn-1,4-diol (58.0 g, 184 mmol, 1.2 eq.) were added to the reaction mixture and the reaction stirred for 16 hours at room temperature under nitrogen. The reaction mixture was then filtered through a pad of alumina. The filtrate was evaporated to dryness. The resulting brown oil was purified via silica column chromatography using 30% dichloromethane in hexanes (Rₜ=0.35) yielding the target cycloadduct 3 as a pale yellow oil (43.1 g 67%). 1H-NMR (500 MHZ, CDCl₃) δ 6.18 (m, 2H), 5.74-5.65 (m, 4H), 4.30-4.17 (m, 4H), 3.49 (m, 2H), 0.89 (s, 18H), 0.04 (s 12H).

### 4. Synthesis of TBS Protected Dimethanol Bullvalene (4)

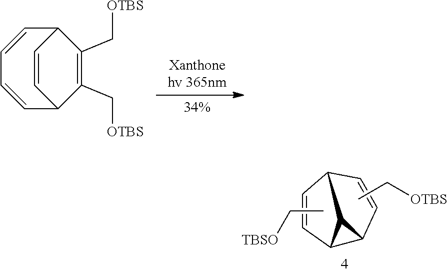

Xanthone (787 mg, 4.01 mmol, 0.03 eq.) and TBS protected cycloadduct 3 (56.0 g, 134 mmol, 1.00 eq.) were dissolved in acetone (500 mL) then transferred into separate 20 mL vial and capped under air. The reaction mixture was placed in the EvoluChem PhotoRedOx box, irradiated with UV light (λ=365 nm), and stirred at room temperature for 18 hours. Then, the reaction mixture was evaporated to dryness. The resulting yellow solid was purified via repeated column chromatography using 30% dichloromethane in hexanes (Rₜ=0.35) yielding the target 4 as a pale yellow oil (19.0 g, 34% combined yield). The material was then used without further purification. ¹H-NMR (500 MHZ, CDCl₃) δ 5.77 (br, m, 4H), 4.00 (br, m, 4H), 3.5 (br, m, 4H), 0.89 (s, 18H), 0.04 (s, 12H).

### 5. Synthesis of Dimethanol Bullvalene (5)

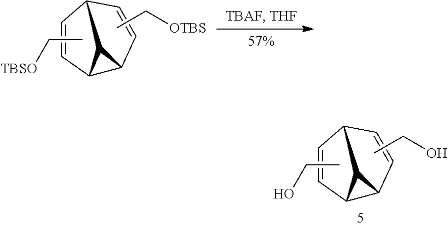

TBS-protected dimethanol bullvalene 4 (3.07 g, 7.33 mmol, 1.00 eq.) was taken up in minimal dry THF under nitrogen and transferred into a 100 mL flame dried flask. Tetrabutylammonium fluoride (TBAF, 1M solution in THF, 19.1 mL, 19.1 mmol, 2.60 eq.) was added to the reaction flask dropwise. The reaction was left to stir under nitrogen for 16 h then concentrated under reduced pressure. The mixture was then diluted with 100 ml water and extracted with 3×70 mL EtOAc. The combined organic layers were then washed with 2×50 mL water, 1×50 mL brine, then evaporated to dryness under reduced pressure. The resulting yellow oil was then purified via silica column chromatography using 0-70% EtOAc in DCM (Rₜ=0.4) yielding the targeted yellow oil (0.795 g, 57%). 1H-NMR (500 MHz, CDCl₃, 25° C.) δ 5.88 (br, m, 4H), 4.03 (br, m, 4H), 2.43 (br, m, 4H).

### 6. Synthesis of Bullvalene Diacrylate (Bull-DA)

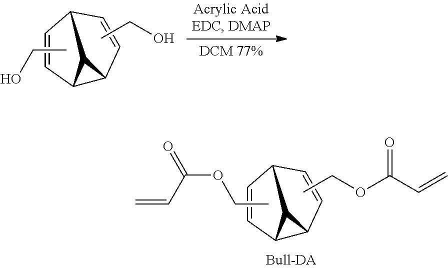

EDC-HCl (4.47 g, 23.3 mmol, 3.00 eq.) and 4-(dimethylamino)pyridine (DMAP, 47.5 mg, 0.389 mmol, 0.0500 eq.) were suspended in 50 mL of DCM and cooled in an ice bath. Acrylic acid (1.60 mL, 23.3 mmol, 3.00 eq.) was then added to the mixture followed by dimethanol bullvalene 5 (1.48 g, 7.78. mmol, 1.00 eq.). The mixture was left to stir at room temperature for 48 h then diluted with 100 mL of DCM and washed with 3×50 mL saturated NaHCO₃ solution, 2×50 mL water, and 1×50 mL brine. The combined aqueous layers were re-extracted with 100 mL of DCM. The combined organic layers were then passed through a pad of silica and the solvent was removed under reduced pressure to afford Bull-DA as a pale yellow oil (1.79 g, 77%). 1H-NMR (500 MHz, CDCl₃, 25° C.) δ 6.39 (d, 2H), 6.12 (dd, 2H), 6.01-5.61 (br, m, 6H), 4.66-4.31 (br, m, 4H), 2.76-1.94 (br, m, 4H). ¹³C-NMR (125 MHz, CDCl₃, 25° C.) δ 166.01, 134.5 (br), 131.0, 128.32, 127.0-124.5 (br), 70.0-69.0 (br), 34.6 (br), 21.0-19.0 (br). HRMS (ESI): m/z calcd for C₁₈H₁₈O₄Na [MNa⁺] 321.1097. found 321.1096; calcd for C₁₈H₂₂O₄N [MNH₄⁺] 316.1543. found 316.1543.

### 7. Synthesis of Adamantane Dicarboxylate (S1)

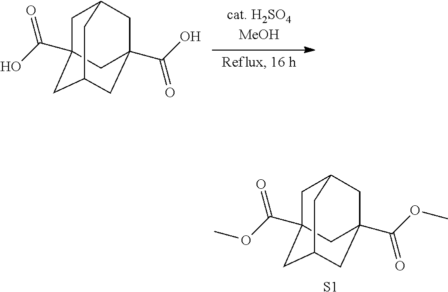

Adamantane dicarboxylic acid (20.0 g, 89.2 mmol) was suspended in 200 mL MeOH in a 500 mL round bottom flask equipped with a condenser. Concentrated H₂SO₄ (10 mL) was added to the reaction mixture dropwise. The mixture was heated to reflux for 16 h. MeOH was then removed under reduced pressure. 200 mL of water was added to the resulting white mixture, then extracted with 3×100 mL EtOAc. The combined organic layer was washed with 2×100 ml water and 1×100 mL brine. Solvent was removed under reduced pressure to afford the targeted white solid S1 (21.76 g, 97%). ¹H-NMR (500 MHZ, CDCl₃) δ 3.66 (s, 6H), 2.15 (m, 2H), 2.03 (s, 2H), 1.92-1.80 (m, 8H), 1.68 (m, 2H). Characterization data agrees with the literature.²

### 8. Synthesis of Adamantane Dimethanol (S2)

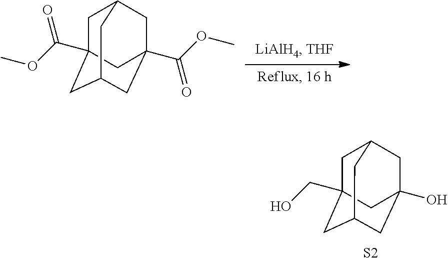

Adamantane dimethyl ester S1 (10.0 g, 39.6 mmol) was dissolved in 200 ml of dry THF and added dropwise in to a 500 mL round bottom flask with LiAlH₄ (6.00 g, 158 mmol, 4.00 eq.) suspended in 100 ml of dry THF under nitrogen. The reaction was brought to a light reflux and left to stir overnight. The mixture was then cooled in an ice bath and a solution of NaOH (100 mL, 5 wt %) was added dropwise. The organic layer was then separated through decantation. The solid residual was washed with 4×100 mL THF. The combined organic layer was then concentrated under reduced pressure to afford the target S2 as a white powder (5.86 g, 75%). ¹H-NMR (500 MHZ, CDCl₃) δ 4.28 (t, J=5.5 Hz, 2H), 2.98 (d, J=5.5 Hz, 4H), 1.97 (m, 2H), 1.53 (s, 2H), 1.40 (m, 4H), 1.31 (d, 4H), 1.12 (s, 2H). Characterization data agrees with the literature.²

### 9. Synthesis of Adamantane Dimethanol Diacrylate (Ad-DA)

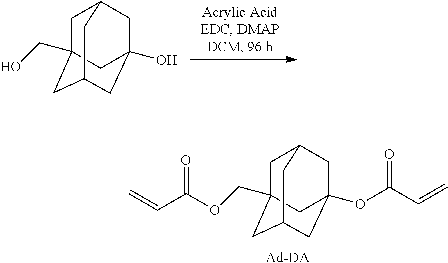

EDC-HCl (34.3 g, 179 mmol, 6.00 eq.) and 4-(dimethylamino)pyridine (DMAP, 364 mg, 2.90 mmol, 0.100 eq.) were suspended in 100 mL of DCM and cooled in an ice bath. Acrylic acid (12.3 mL, 179 mmol, 6.00 eq.) was then added to the mixture followed by adamantane dimethanol S2 (5.86 g, 29.9 mmol, 1.00 eq.). The mixture was left to stir at room temperature for 48 h then diluted with 200 mL of DCM and washed with 3×100 mL saturated NaHCO₃ solution, 2×50 mL water, 1×50 mL brine. The combined aqueous layers were re-extracted with 100 mL of DCM. The combined organic layers were then passed through a pad of silica and solvent removed under reduced pressure to afford the Ad-DA as a pale yellow oil (4.32 g, 48%). 1H-NMR (500 MHz, CDCl₃) δ 6.40 (d, J=17.3 Hz, 2H), 6.14 (dd, J=17.3 Hz, 10.4 Hz, 2H), 5.83 (d, J=10.5 Hz 2H), 3.81 (s, 4H), 2.11 (m, 2H), 1.65 (m, 2H), 1.56 (m, 4H), 1.50 (m, 4H), 1.38 (s, 2H). ¹³C-NMR (125 MHz, CDCl₃) δ 166.42, 130.63, 128.66, 73.62, 41.09, 38.82, 36.36, 33.86, 27.98. HRMS (ESI): m/z calcd C₁₈H₂₈O₄N [MNH₄⁺] 322.2013. found 322.2012.

### 10. Synthesis of Trimethylsilyl Bicyclo[4.2.2]deca-2,4,7,9-tetraene (S3)

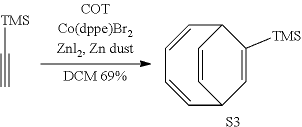

CoBr₂(dppe) (1.18 g, 1.92 mmol, 0.100 eq.), ZnI₂ (1.22 g, 3.84 mmol, 0.200 eq.), and Zn (0.376 g, 5.76 mmol, 0.300 eq.) were added to a flame dried flask with a magnetic stir bar. The flask containing solids was evacuated and refilled 3 times. Then, 50 mL dry, degassed DCM was added, and the mixture stirred for 15 minutes under nitrogen. Cyclooctatetraene (2.16 mL, 19.2 mmol, 1.00 eq.) and TMS acetylene (4.10 mL, 28.8 mmol, 1.50 eq.) were added to the reaction mixture and the reaction stirred for 16 hours at room temperature under nitrogen. The reaction mixture was then filtered through a pad of alumina. The filtrate was evaporated to dryness. The resulting brown oil was purified via silica column chromatography using hexanes (Rₜ=0.5) yielding the target cycloadduct S4 as a pale yellow powder (2.68 g, 69%). 1H-NMR (500 MHZ, CDCl₃) 6.13 (m, 2H), 5.88 (m, 1H), 5.72 (m, 4H), 3.35 (m, 1H), 4.24 (m, 1H), 0.07 (s, 9H). Characterization data agrees with the literature.³

### 11. Synthesis of Trimethylsilyl Bullvalene (TMS-Bullvalene)

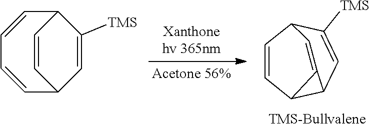 [SMILES: C[Si](C)(C)C1=CC2C=CC1/C=C\C=C/2 ; C[Si](C)(C)C1=CC2C3=CC1C=CC32]

Xanthone (85.0 mg, 0.398 mmol, 0.0300 eq.) and S4 (2.68 g, 13.3 mmol, 1.00 eq.) were dissolved in acetone (20 mL) then transferred into a separate 20 mL vial and capped under air. The reaction mixture was placed in the EvoluChem PhotoRedOx box, irradiated with UV light (λ=365 nm), and stirred at room temperature for 96 hours. Then, the reaction mixture was evaporated to dryness. The resulting yellow solid was purified via silica column chromatography using hexanes (Rₜ=0.55) yielding the target TMS-Bullvalene as a pale yellow oil (1.50 g, 56%). The material was then used without further purification. 1H-NMR (500 MHZ, CDCl₃) δ=6.42-5.13 (br, m, 5H), 3.00-1.75 (br, m, 4H), 0.06 (s, 9H).

### Bullvalene Radical Stability Test:

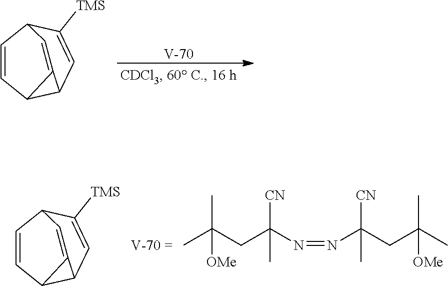

TMS-Bullvalene (50 mg, 0.247 mmol, 7.00 eq.) and V-70 (10.9 mg, 0.0352 mmol, 1.00 eq.) were dissolved in 1 mL of CDCl₃ in a sealed NMR tube. An initial 1H NMR spectrum was taken before the tube was placed in a pre-heated oven at 60° C. for 16 h. 1H NMR spectrum was then recorded again after heating. The vinyl TMS proton resonance (0.07 ppm, 9H) was used as an internal standard and integrated against the broad bullvalene vinyl proton peaks (6.5-5.0 ppm, 5H at 25° C. and 0° C.). No significant change in the integration ratio between such protons before and after heating to 60° C. for 16 h (FIG. 11).

### Network Preparations:

Crosslinker X-DA (7, 5, 2 mol %), n-butyl acrylate (100 mol %) and V-70 (1 mol %) were dissolved with 200 total wt % of toluene in a 20 mL vial. Teflon molds were pre-heated to 60° C. for 6 h in a Cole-Parmer OVV-400-24-120 Programmable Vacuum Oven. The curing mixture was then transferred into the preheated Teflon mold under positive flow of nitrogen. The oven was then closed and purged with nitrogen for 3 minutes, then left at 60° C. for 16 h under ambient pressure. The curing mixture was then quenched by exposing to air. The resulting thermoset was then air dried for 16 h, then further dried under vacuum (<0.2 Torr for 16 h). Since all X-Net-Y materials have low T_{g,DSC} (−34° C. to −46° C.), no additional steps were taken to remove thermal history prior to subsequent measurements.

### Materials Characterization: Thermogravimetric Analysis

TABLE 3
Monomer Conversion

| Material | Conversion* (%) |
|---|---|
| Bull-Net-7 | 80 |
| Ad-Net-7 | 82 |
| Hex-Net-7 | 75 |
| Bull-Net-5 | 77 |
| Ad_{2.5}Bull_{2.5}-Net-5 | 80 |
| Ad_{3.75}Bull_{1.25}-Net-5 | 85 |
| Ad-Net-5 | 72 |
| Bull-Net-2 | 76 |
| Ad-Net-2 | 81 |

*Conversion measured gravimetrically after drying

### Helium Pycnometry Data

TABLE 4
Helium pycnometry raw data at 25° C.

| | Bull-Net-7 | Ad-Net-7 | Hex-Net-7 |
|---|---|---|---|
| Run # | (g/cm³) | (g/cm³) | (g/cm³) |
| 1 | 1.0913 | 1.0755 | 1.0649 |
| 2 | 1.0916 | 1.0765 | 1.0639 |
| 3 | 1.0910 | 1.0760 | 1.0652 |
| 4 | 1.0914 | 1.0755 | 1.0651 |
| 5 | 1.0921 | 1.0746 | 1.0648 |
| 6 | 1.0910 | 1.0753 | 1.0644 |
| 7 | 1.0903 | 1.0759 | 1.0649 |
| 8 | 1.0904 | 1.0753 | 1.0643 |
| True ρ (g/cm³) | 1.0911 (0.02) | 1.0756 (0.02) | 1.0647 (0.02) |

### DMA Cyclic Loading Experiments

TABLE 5
Youngs modulus (E) of X-Net-7 in MPa at 20° C.

| n | Bull-Net-7 | Ad-Net-7 | Hex-Net-7 |
|---|---|---|---|
| 1 | 0.0021 | 0.0028 | 0.0033 |
| 2 | 0.0022 | 0.0029 | 0.0039 |
| 3 | 0.0024 | 0.0022 | 0.0041 |
| Average E | 0.0022(0.0002) | 0.0026 (0.0004) | 0.0038 (0.0004) |
| (MPa) | | | |

E calculated through the initial slope of the strain-stress curve

TABLE 6
Youngs modulus (E) of X-Net-7 in MPa at −40° C.

| n | Bull-Net-7 | Ad-Net-7 | Hex-Net-7 |
|---|---|---|---|
| 1 | 8.75 | 4.26 | 0.115 |
| 2 | 7.96 | 2.76 | 0.149 |
| 3 | 8.74 | 4.38 | 0.0657 |
| Average E (MPa) | 8.5 (0.5) | 3.8 (0.9) | 0.11 (0.04) |

E calculated through the initial slope of the strain-stress curve

### REFERENCES FOR SUPPORTING INFORMATION FOR EXPERIMENTAL

### Example 1

(1) Chen, C. et al., ACS Cent Sci 2023, 9 (4), 639-647.
(2) Averina, E. B. et al., J. Org. Chem. 2014, 79 (17), 8163-8170.
(3) Yahiaoui, O. et al., Angew. Chem. Int. Ed. 2018, 57, 2570
(4) Averina, E. B. et al., J. Org. Chem. 2014, 79 (17), 8163-8170.
(5) (a) Lee, C. et al., Phys. Rev. B 1988, 37, 785-789. (b) Becke, A. D., J. Chem. Phys. 1993, 98, 5648-5652.
(6) (a) Grimme, S., J. Comput. Chem. 2004, 25, 1463-1473. (b) Grimme, S. et al., J. Chem. Phys. 2010, 132, 154104. (c) Grimme, S., WIRES Comput. Mol. Sci. 2011, 1, 211-228. (d) Ehrlich, S. et al., Acc. Chem. Res. 2012, 46, 916-926.
(7) (a) Weigend, F. et al., Phys. Chem. Chem. Phys. 2005, 7, 3297-3305. (b) Weigend, F., Phys. Chem. Chem. Phys. 2006, 8, 1057-1065.
(8) (a) Klamt, A. et al., J. Chem. Soc. Perkin Trans. 2 1993, 0, 799-805. (b) Tomasi, J. et al., Chem. Rev. 1994, 94, 2027-2094. (c) Andzelm, J. et al., J. Chem. Phys. 1995, 103, 9312-9320. (d) Barone, V.; et al., J. Phys. Chem. A 1998, 102, 1995-2001. (e) Cossi, M. et al., J. Comput. Chem. 2003, 24, 669-681.
(9) Gaussian 16, Revision C.01, Frisch, M. J. et al., Gaussian, Inc., Wallingford CT, 2016.
(10) Legault, C. Y. (2009) CYLview, 1.0b, Université de Sherbrooke: Sherbrooke, Canada.
(11) Wick, C. R. et al., Forces in Mechanics 2022, 9, 100143.
(12) Klein, I. M. et al., J Am Chem Soc 2020, 142, 16364-16381.

### Example 2

In Experimental Example 2, bullvalene crosslinkers are incorporated into poly(methyl methacrylate) (PMMA) networks to examine the consequences of bullvalene fluxionality on glass formation using dynamic mechanical analysis (DMA). It is hypothesized that bullvalene rearrangements will introduce additional modes of local molecular motion to minimize v₁₀ and resist rapid viscosity changes with temperature, ultimately leading to stronger glass formation (FIG. 43B).

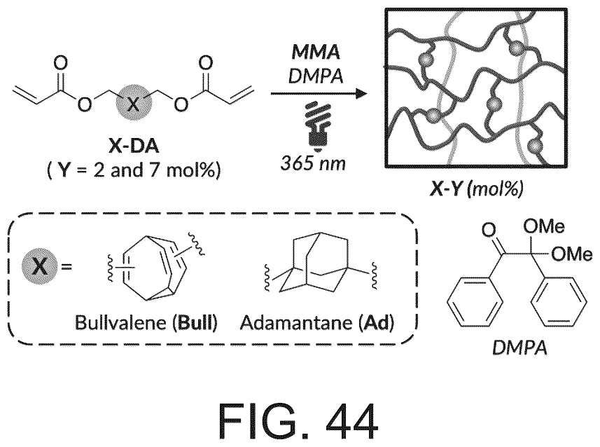

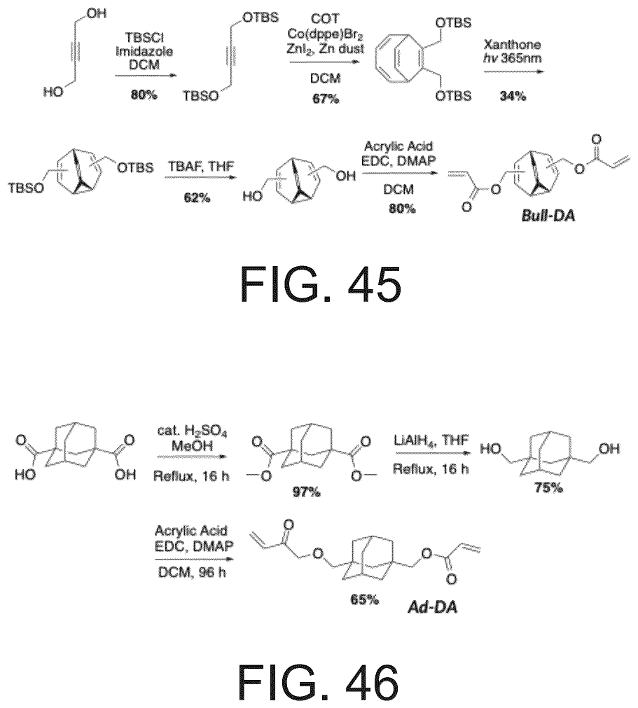

The desired polymer materials for dynamic mechanical analysis were synthesized by combining methyl methacrylate (MMA) and appropriate diacrylate crosslinkers (2 mol % or 7 mol % loadings) under photochemical free-radical polymerization condition (DMPA, 365 nm, 1 h, FIG. 44). Fluxional PMMA networks were crosslinked using bullvalenyl diacrylate (Bull-DA), the synthesis of which (FIGS. 45 and 46) is adapted from the prior work of Fallon.^{30,39,46} To control for molecular fluxionality, adamantane diacrylate (Ad-DA) was used as a static control; it is also a C₁₀ carbon cage with similar steric demands to bullvalene but without the possibility of sigmatropic rearrangements.

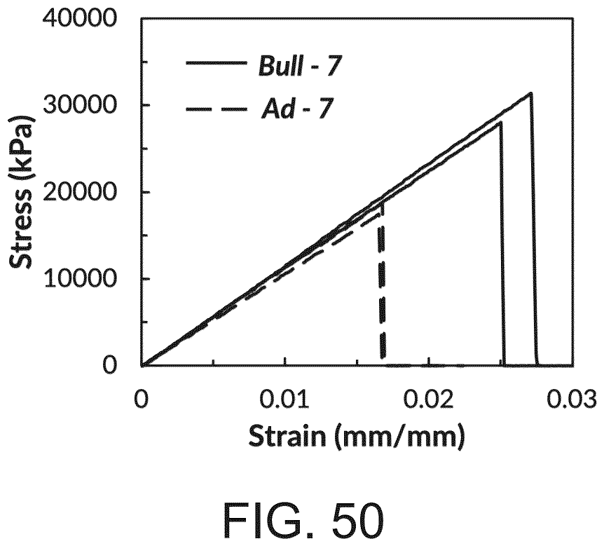

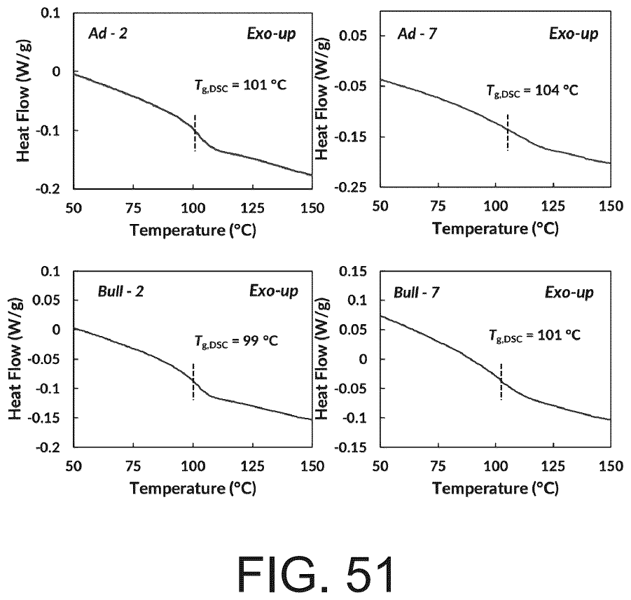

The resultant thermosets likely have similar network structures because the work described in Example 1, with butyl acrylate (BA) thermosets crosslinked by Bull-DA and Ad-DA are nearly indistinguishable as assessed by thermogravimetric analysis, differential scanning calorimetry, small angle X-ray scattering, helium pycnometry, swelling tests, and DMA frequency sweep experiments.³⁰ Indeed, the synthesized bullvalene and adamantane PMMA networks (Bull-Y and Ad-Y; Y=2 or 7 mol %) show similar decomposition temperature (T_{d}) at the same crosslink density of 2 or 7% measured by thermogravimetric analysis (TGA, T_{d}=309° C., 298° C., 266° C., 279° C. for Bull-7, Ad-7, Bull-2 and Ad-2 respectively, Table 7, FIG. 50). At matched crosslink density, materials also show similar thermal glass transition temperatures (T_{g,DSC}) analyzed through differential scanning calorimetry (DSC, FIG. 51). For example, at 7% crosslink, Bull-7 has a T_{g,DSC} of 101° C. while Ad-7 at 104° C. With similar Ta and T_{g,DSC} for the PMMA networks, it was concluded that these materials also have comparable network structures and are suitable for subsequent mechanical and thermomechanical analysis.

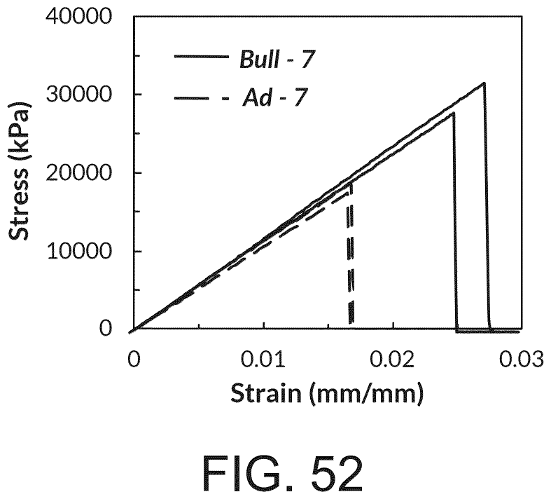

First, the mechanical properties of Bull-7 and Ad-7 were studied at room temperature (ca. 25° C.) by uniaxial tensile testing. The Young's moduli (E) of Bull-7 and Ad-7, calculated from the initial slope of the stress-strain curve, revealed that Bull-7 is slightly stiffer (E=1.17 GPa) than Ad-7 (E=1.12 GPa, Table 7, FIG. 52). Interestingly, Bull-7 was able to sustain 62% higher elongation before brittle failure (ε_{break}=0.026%) compared to Ad-7 (ε_{break}=0.016%). It is possible that in Bull-7, bullvalene's mechanically guided thermal rearrangements and/or mechanically activated rearrangements dissipate applied force upon deformation, causing the materials to be more extensible than its static Ad-7 counterpart.

TABLE 7
Summary of network thermal and thermomechanical properties

| | T_{d} | T_{g, DSC} | T_{g, DMA} | E | ε_{break} |
|---|---|---|---|---|---|
| Sample | (° C.)^{a} | (° C.) | (° C.) | (GPa) | (mm/mm) |
| Bull - 7 | 309 | 101 | 137 | 1.17 | 0.026 |
| Ad - 7 | 298 | 104 | 140 | 1.12 | 0.016 |
| Bull - 2 | 266 | 99 | 136 | — | — |
| Ad - 2 | 279 | 101 | 136 | — | — |

^{a}10% decomposition temperature

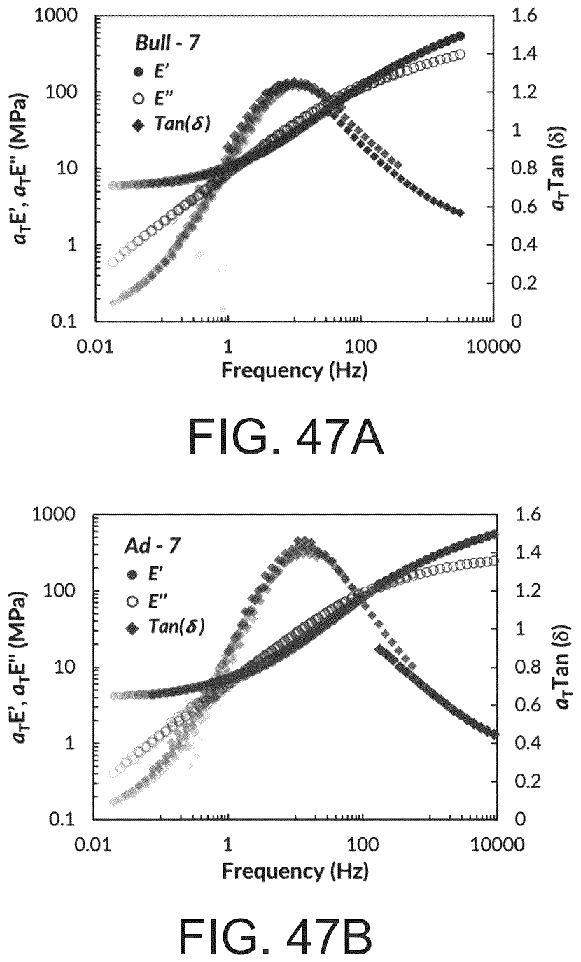

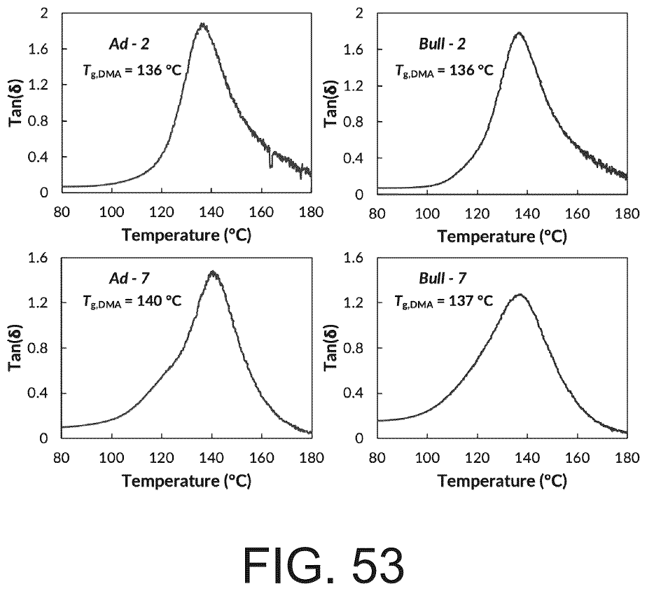

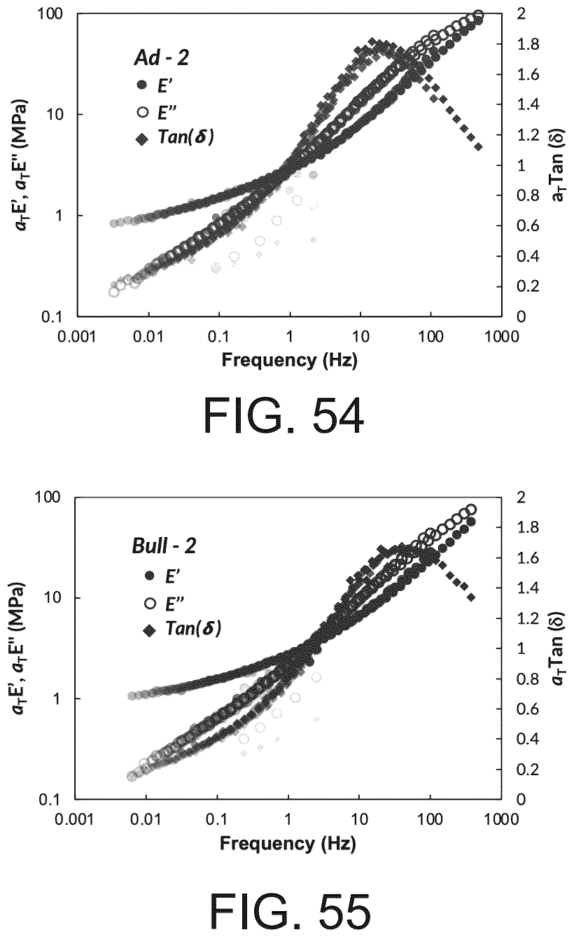

To study the fragility of the PMMA networks, first, the thermomechanical glass transition temperatures (T_{g,DMA}) were measured through temperature sweep experiments using DMA. The T_{g,DMA} of Bull-7 and Ad-7 were measured to be 137° C. and 140° C., respectively, at the apex of the tan (8) peak (Table 7, FIG. 53). Bull-2 and Ad-2 have the same T_{g,DMA} at 136° C. which were slightly lower than that of the 7% crosslink materials. Then, master curves were generated from frequency sweep experiments at different temperatures using the principle of time-temperature superposition (FIG. 47 and FIGS. 54 and 55).

To initially probe dynamic fragility on the Bull-Y and Ad-Y materials, Angell plots were constructed. With the necessary master curves in hand, the shift factor, α_{T}, is obtained using the principle of time-temperature superposition. The Vogel-Fulcher-Tammann (VFT) relationship was then adapted to the William-Landel-Ferry (WLF) function (Equation 3) using the direct correlation between viscosity, relaxation time, and shift factor a_{T}, where T and T_{g} are the experimental temperature and the glass transition temperature, respectively:^{29,47,48}

$${m}_{Angell} = \frac{d log {α}_{T}}{d ( {T}_{g} / T )} {\vert}_{T = {T}_{g}} \qquad ( 3 )$$

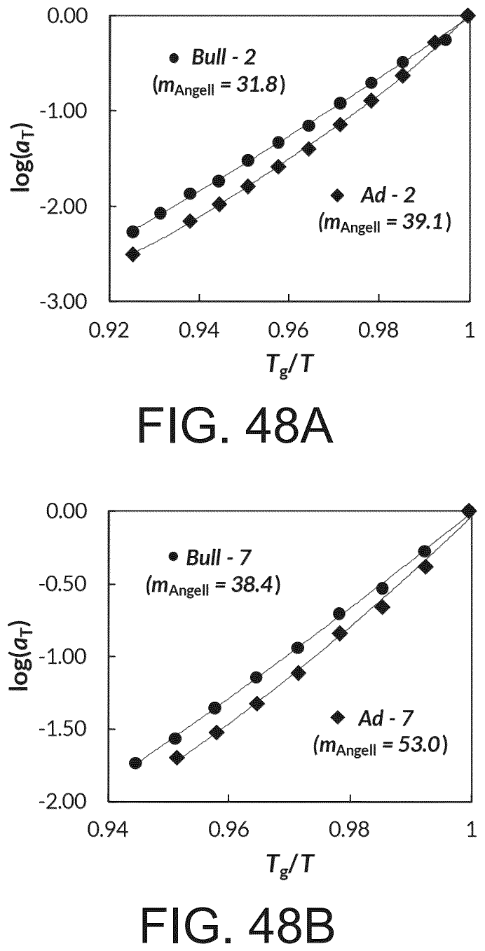

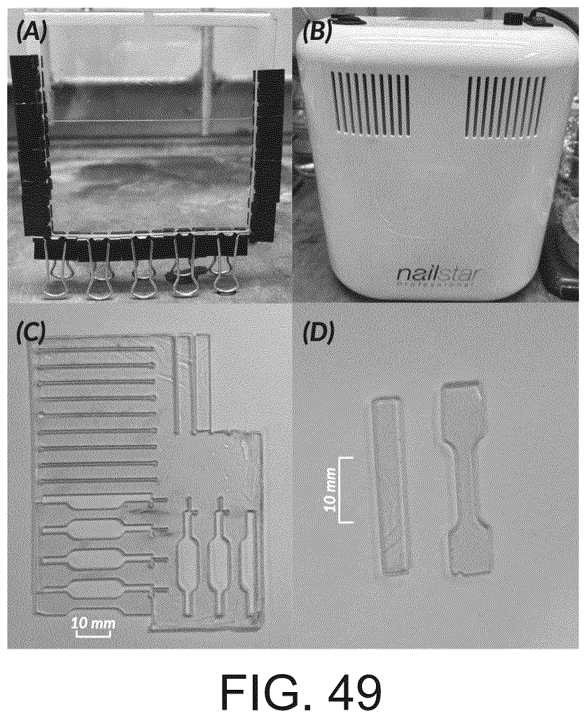

Based on Equation 3, Angell plots were then constructed by taking log(α_{T}) at or above the glass transition temperature in relation to temperature (T_{g,DMA}/T, FIG. 48).^{47,49} In these plots, the more gradual increase in slope of log(α_{T}) vs. T_{g,DMA}/T for Bull-Y materials relative to Ad-Y materials qualitatively demonstrates that bullvalene incorporation results in stronger glasses than static adamantane at both 2 mol % and 7 mol % crosslink densities. To quantify these differences, the derivative of each Angell plot was calculated at T_{g} (i.e., T_{g}/T=1) to obtain dynamic fragility indices (m_{Angell}) for Bull-Y and Ad-Y materials (Table 8 and Table 9-12).^{13.44} At a lower crosslink density, Bull-2 has a lower m_{Angell}=31.8 compared to Ad-2 (m_{Angell}=39.1, FIG. 48A). A similar trend is shown at a higher crosslink density, where Bull-7 has m_{Angell}=38.4, a 27.6% decrease relative to that of Ad-7 (m_{Angell}=53.0) (FIG. 48B).

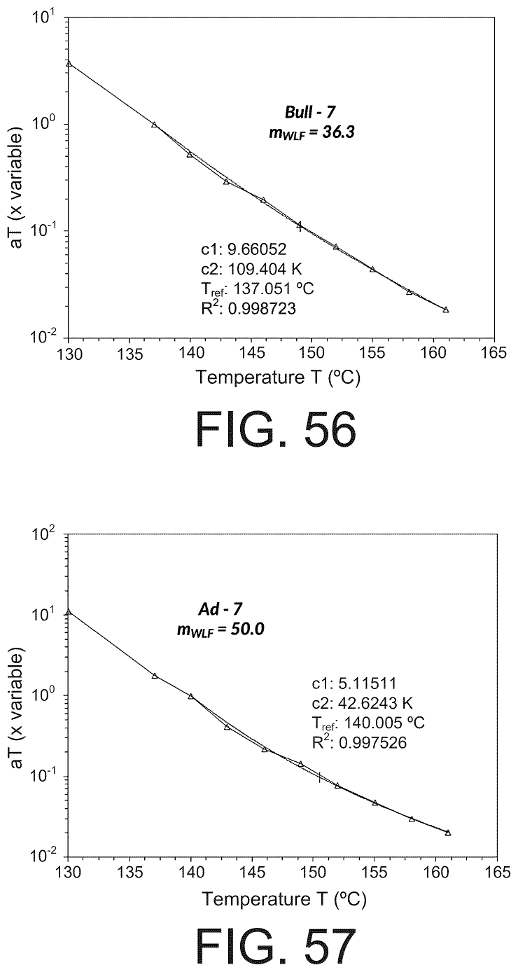

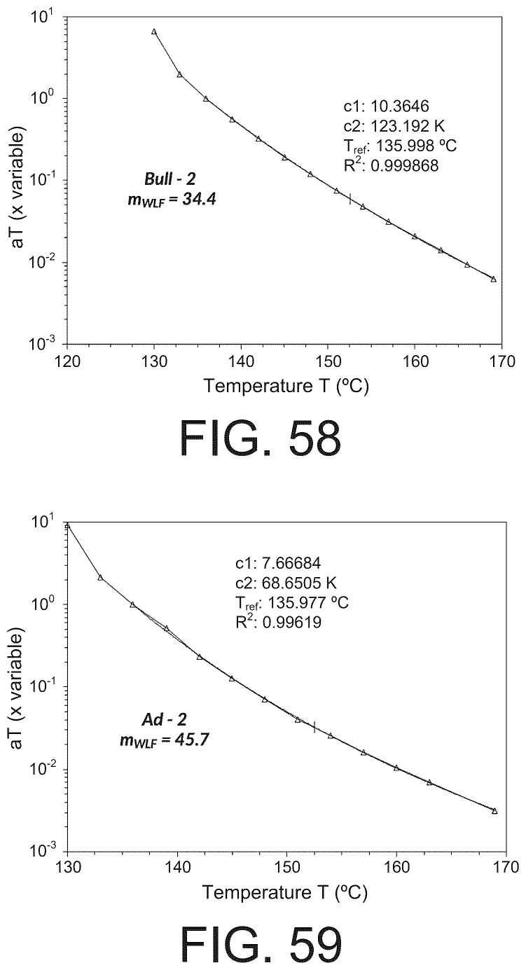

To further quantify the strengthening of glass formation through bullvalene incorporation, a second method to assess the dynamic fragility indices of these materials was used. Using the master curves for Bull-Y and Ad-Y (FIG. 47, FIGS. 56-59), log (6 T) was fit at a selected reference temperature (thermomechanical glass transition temperature, T_{g,DMA}) at temperatures equal and above T_{g,DMA} using the WLF equation (Equation 4) to obtain materials constants C₁ and C₂.⁵⁰ By combining Equation 3 and Equation 4, the resulting fragility index,^{13,14,29,47} m_{WLF}, can be simplified in Equation 5:

$$log {α}_{T} = \frac{{C}_{1} ( T - {T}_{ref} )}{{C}_{2} + T - {T}_{ref}} \qquad ( 4 )$$

$${m}_{WLF} = \frac{{C}_{1}}{{C}_{2}} {T}_{g} \qquad ( 5 )$$

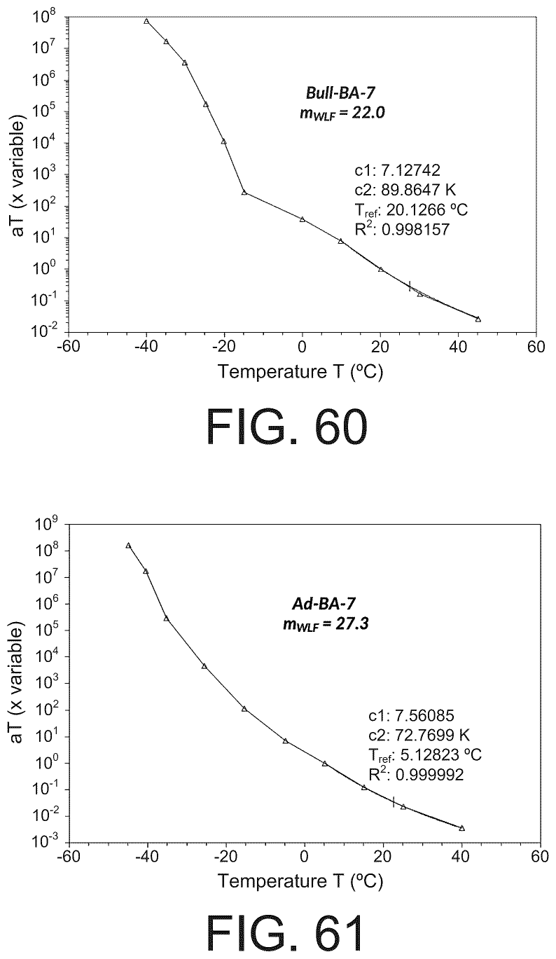

Importantly, the values of m_{WLF} show good agreement with those of m_{Angell} across all materials (Table 8). Bull-Y materials form stronger glasses at both crosslink densities compared to Ad-Y. Bull-7 has a m_{WLF}=36.3, which is 27.4% lower than that of Ad-7 (m_{WLF}=50.0). The same trend is also observed at lower crosslinker loadings where Bull-2 has a lower m_{WLF} (34.4) compared to that of Ad-2 (m_{WLF}=45.7). In addition to the PMMA networks reported herein, the shift factors from previously reported BA networks (i.e., Bull-BA-7 and Ad-BA-7) 30 were refit with WLF equation using only data points at or above glass transition temperature (vide supra) to obtain the WLF constants C₁ and C₂ (FIGS. 60 and 61).^{47,49} Interestingly, these resulting fragility indices also suggested that Bull-BA-7 forms a stronger glass than Ad-BA-7 (m_{WLF}=22.0 and 27.3 for Bull-BA-7 and Ad-BA-7, respectively). Hence, independent of the matrix used (i.e., MMA or BA), bullvalene-crosslinked thermosets form stronger glasses than those crosslinked using static adamantane.

TABLE 8
Calculated fragility indices of PMMA and BA networks

| Sample | m_{Angell} | T_{g, DMA} (K) | C₁ | C₂ (K) | m_{WLF} |
|---|---|---|---|---|---|
| Bull - 7 | 38.4 | 410 | 9.66 | 109 | 36.3 |
| Ad - 7 | 53.0 | 413 | 5.11 | 42.6 | 50.0 |
| Bull - 2 | 31.8 | 409 | 10.4 | 123 | 34.4 |
| Ad - 2 | 39.1 | 409 | 7.67 | 68.7 | 45.7 |
| Bull-BA-7^{a} | — | 278 | 7.12 | 89.9 | 22.0 |
| Ad-BA-7^{a} | — | 264 | 7.56 | 72.8 | 27.3 |

^{a}Data obtained from Ref. 30³⁰

From these collective findings, it is possible that molecular fluxionality is the origin of stronger glass formation (i.e., dynamic fragility is decreased). Unlike adamantane, bullvalene brings additional local molecular motion under tension through mechanically-guided thermal rearrangements and/or mechanochemically activated rearrangements.³⁰ As the experimental temperature decreases towards T_{g}, the rate of all relaxation processes begin to decrease. Nevertheless, bullvalene can still adapt to a given local environment to optimize molecular packing through Hardy-Cope rearrangements, thereby decreasing v₁₀ and ultimately forming a stronger glass.

In summary, additional implications of molecular fluxionality on the bulk properties of thermosetting materials are demonstrated by incorporating bullvalene into crosslinked PMMA networks. Uniaxial tensile tests show that Bull-7 has a higher elongation at break than static control Ad-7. Fragility indices, m, calculated using two methods (i.e., from the derivative of Angell plots and through the WLF equation) show good agreement within individual samples. Across 2 mol % and 7 mol % crosslink densities, bullvalene materials exhibit lower fragility indices than static adamantane controls. It can be concluded that bullvalene rearrangements offer additional local molecular motion to the relaxation mechanism in polymer thermosets, suppressing long range segmental motion and preventing steep viscosity deviations with temperature changes. This unique paradigm for accessing stronger polymer glasses is envisioned to have implications in novel organic materials for applications in advanced optics and engineering.

### REFERENCES FOR EXAMPLE 2

(1) Gibbs, J. H. Nature of the Glass Transition in Polymers. J. Chem. Phys. 1956, 25 (1), 185-186.
(2) Hiemenz, P. C.; Lodge, T. Polymer Chemistry, 2nd ed.; CRC Press: Boca Raton, 2007.
(3) Angell, C. A., J. Non-Cryst. Solids 1985, 73 (1), 1-17.
(4) Angell, C. A., J. Non-Cryst. Solids 1991, 131-133, 13-31.
(5) Ediger, M. D. et al., J. Phys. Chem. 1996, 100 (31), 13200-13212.
(6) Adachi, T. et al., J. Appl. Polym. Sci. 2002, 86 (9), 2261-2265.
(7) Ciarella, S. et al., Proc. Natl. Acad. Sci. 2019, 116 (50), 25013-25022.
(8) Liu, C. et al., Macromolecules 2015, 48 (12), 4196-4206.
(9) Kunal, K. et al., Macromolecules 2008, 41 (19), 7232-7238.
(10) Evans, C. M. et al., Macromolecules 2013, 46 (15), 6091-6103.
(11) Arabeche, K. et al., Polymer 2014, 55 (6), 1546-1551.
(12) Delpouve, N. et al., Macromolecules 2014, 47 (15), 5186-5197.
(13) Charitos, I. et al., Polym. Compos. 2023, 44 (9), 5619-5632.
(14) Zuza, E. et al., Polymer 2008, 49 (20), 4427-4432.
(15) Alves, N. M. et al., Macromolecules 2004, 37 (10), 3735-3744.
(16) Sastry, S. et al., Nature 1998, 393 (6685), 554-557.
(17) Saika-Voivod, I. et al., Nature 2001, 412 (6846), 514-517.
(18) Krausser, J. et al., Proc. Natl. Acad. Sci. 2015, 112 (45), 13762-13767.
(19) Dalle-Ferrier, C. et al., J. Chem. Phys. 2016, 145 (15), 154901.
(20) Ma, Q. et al., AIP Adv. 2022, 12 (1), 015207.
(21) Ngai, K. L. et al., Macromolecules 1993, 26 (25), 6824-6830.
(22) Plazek, D. J. et al., Macromolecules 1991, 24 (5), 1222-1224.
(23) Ngai, K. L., J. Non-Cryst. Solids 2000, 275 (1), 7-51.
(24) Angell, C. A. et al., J. Appl. Phys. 2000, 88 (6), 3113-3157.
(25) Böhmer, R. et al., J. Chem. Phys. 1993, 99 (5), 4201-4209.
(26) Beiner, M. et al., Nat. Mater. 2003, 2 (9), 595-599.
(27) Berthier, L. et al., Science 2005, 310 (5755), 1797-1800.
(28) White, R. P. et al., Macromolecules 2016, 49 (11), 3987-4007.
(29) Colucci, D. M. et al., MRS Online Proc. Libr. 1996, 455 (1), 171-176.
(30) Sun, P. B. et al., J. Am. Chem. Soc. 2024, 146 (28), 19229-19238.
(31) Pomfret, M. N. et al., Angew. Chem. Int. Ed. 2023, 62 (19), e202301695.
(32) Schröder, G. et al., Angew. Chem. Int. Ed. Engl. 1967, 6 (5), 414-423.
(33) von E. Doering, W. et al., Tetrahedron 1963, 19 (5), 715-737.
(34) Cope, A. C.; Hardy, E. M., J. Am. Chem. Soc. 1940, 62 (2), 441-444.
(35) Bismillah, A. N. et al., Chem. Sci. 2020, 11 (2), 324-332.
(36) Ferrer, S. et al., Synthesis 2019, 51 (5), 1037-1048.
(37) Ives, R. A. et al., Chem. Sci. 2024, 15 (36), 14608-14617.
(38) Hussein, B. A.; Maturi, W.; Rylands, M. K.; Bismillah, A. N.; Wen, Y.; Aguilar, J. A.; Ayub, R.; Rankine, C. D. et al., Chem. Sci. 2024, 15 (36), 14618-14624.
(39) Yahiaoui, O. et al., Angew. Chem. Int. Ed. 2018, 57 (10), 2570-2574.
(40) Lippert, A. R. et al., J. Am. Chem. Soc. 2010, 132 (44), 15790-15799.
(41) Teichert, J. F. et al., J. Am. Chem. Soc. 2013, 135 (30), 11314-11321.
(42) Ottonello, A. et al., Proc. Natl. Acad. Sci. 2023, 120 (15), e2208737120.
(43) Reimers, J. R. et al., Nat. Commun. 2023, 14 (1), 6089.
(44) Meier, B. H. et al., J. Am. Chem. Soc. 1985, 107 (19), 5553-5555.
(45) Müller, A. et al., Mol. Phys. 1994, 81 (5), 1239-1258.
(46) Patel, H. D. et al., J. Am. Chem. Soc. 2020, 142 (8), 3680-3685.
(47) Dudowicz, J. et al., J. Chem. Phys. 2015, 142 (1), 014905.
(48) Huang, D. et al., J. Chem. Phys. 2001, 114 (13), 5621-5630.
(49) Angell, C. A., J. Res. Natl. Inst. Stand. Technol. 1997, 102 (2), 171.
(50) Williams, M. L. et al., J. Am. Chem. Soc. 1955, 77 (14), 3701-3707.

### SUPPORTING INFORMATION FOR EXPERIMENTAL EXAMPLE 2

### General Considerations:

Materials. All reagents were purchased from commercial suppliers and used as received unless otherwise noted. Methyl methacrylate was passed through a pad of basic alumina prior to use. Glassware was flame dried or dried in an oven overnight at 120° C. before use. Moisture and air-sensitive reactions were performed under inert atmosphere (nitrogen) using standard Schlenk technique. SiliaFlash F60 (40-63 μm, 230-400 mesh) silica gel was used for column chromatography.

Characterization. ¹H nuclear magnetic resonance (¹H NMR) spectra were obtained on a Bruker AVANCE-300, Bruker AVANCE-500, or Bruker DRX-500 NMR spectrometer. Thermogravimetric analysis (TGA) data was collected using a TA Discovery Q5000 thermogravimetric analyzer. Tests were conducted using ramp rate of 10° C./min starting from operating temperature (ca. 35° C.) to 500° C. under N₂. Differential scanning calorimetry (DSC) data was collected using a TA Discovery DSC 2500. 6 mg to 7 mg of samples were heated from room temperature to 200° C. (heating rate=10° C. per minute) followed by cooling to between 0° C. and −80° C. (cooling rate=20° C. per minute) to clear the thermal history. Samples were then re-heated 200° C. (heating rate=10° C. per minute) for data collection (“second heat”). Uniaxial tensile tests were conducted using a TestResources 100 series Universal Test Machine with 1.1 kN load cells and tensile grips. Dynamic mechanical analysis (DMA) data was collected using TA Discovery DMA 850 in tensile mode. All oscillatory tests were conducted within the linear viscoelastic region at set temperature as confirmed through strain sweep experiments. Temperature sweep experiments were conducted from 60° C. to 200° C. at 0.015% strain at 3° C./min ramp rate. Master curves were obtained through frequency sweep experiments at selected temperatures (from T_{g,DMA} to T_{g,DMA}+21° C. for every 3° C.) from 1 to 50 Hz. Material constant C₁ and C₂ were calculated by fitting the log of shift factors to temperature at and above T_{g,DMA} to the WLF function with T_{g,DMA} as the reference temperature using TA Instrument Trios software.

Crosslinker Synthesis. The fluxional (Bull-DA) and static (Ad-DA) crosslinkers were synthesized according to previous literature as shown in Scheme S1 and Scheme S2. The 1H NMR spectra of synthesized crosslinkers were consistent with previous work and were used for materials preparation.¹

Network Preparation. General Procedure: Crosslinker X-Y (2 mol % and 7 mol %), methyl methacrylate (100 mol %) and 2, 2-dimethoxy-2-phenylacetylphenone (DMPA, 1 mol %) were mixed in a 20 mL vial then filtered through a 45 μm syringe filter into a 1 mm thick 9 cm×9 cm Teflon mold sandwiched between 2 pieces of glass slides secured by binder clips. The mold containing the curing resin was vertically placed in a UV nail gel curing lamp (365 nm, 4×9 W bulbs) and cured for 1 h.^{2,3} The material was then immediately transferred to a vacuum oven for annealing at 90° C. over 4 h to erase thermal history and remove excess monomer. The resulting rectangular polymer material was then shaped with a ProtoMax water jet into dogbone samples for tensile tests and bars for DMA analysis (FIG. 47).

Bull-7 materials were synthesized by combining 1.02 g (3.41 mmol, 7 mol %) Bull-DA, 5.20 mL (48.8 mmol, 100 mol %) of methyl methacrylate and 125 mg (0.488 mmol, 1 mol %) of DMPA in a glass vial and filtered through a 45 μm syringe filter into the curing mold. The resin was then cured and annealed according to general procedure.

Ad-7 materials were synthesized by combining 0.822 g (2.70 mmol, 7 mol %) Bull-DA, 4.11 mL (38.6 mmol, 100 mol %) of methyl methacrylate and 98.9 mg (0.386 mmol, 1 mol %) of DMPA in a glass vial and filtered through a 45 μm syringe filter into the curing mold. The resin was then cured and annealed according to general procedure.

Materials Characterization. Calculation of m_{Angell}

TABLE 9
Calculation of m_{Angell} of Bull - 7

| T_{g}/T | Log (a_{T}) | d(log(a_{T}))/d(T_{g}/T) |
|---|---|---|
| 1.000 | 0.000 | m_{Angell} = 38.40 |
| 0.992 | −0.279 | 35.89 |
| 0.985 | −0.536 | 24.55 |
| 0.978 | −0.709 | 33.51 |
| 0.971 | −0.942 | 29.63 |
| 0.964 | −1.145 | 31.12 |
| 0.958 | −1.355 | 31.97 |
| 0.951 | −1.568 | 25.62 |
| 0.944 | −1.736 | — |

TABLE 10
Calculation of m_{Angell} of Ad - 7

| T_{g}/T | Log (a_{T}) | d(log(a_{T}))/d(T_{g}/T) |
|---|---|---|
| 1.000 | 0.000 | m_{Angell} = 53.00 |
| 0.992 | −0.382 | 39.76 |
| 0.985 | −0.664 | 25.15 |
| 0.978 | −0.840 | 39.94 |
| 0.971 | −1.116 | 30.63 |
| 0.965 | −1.325 | 29.90 |
| 0.958 | −1.525 | 26.13 |
| 0.951 | −1.698 | — |

TABLE 11
Calculation of m_{Angell} of Bull - 2

| T_{g}/T | Log (a_{T}) | d(log(a_{T}))/d(T_{g}/T) |
|---|---|---|
| 1.000 | 0.000 | m_{Angell} = 31.79 |
| 0.993 | −0.229 | 27.51 |
| 0.985 | −0.425 | 29.02 |
| 0.978 | −0.626 | 28.26 |
| 0.972 | −0.822 | 29.55 |
| 0.965 | −1.022 | 28.06 |
| 0.958 | −1.210 | 26.30 |
| 0.952 | −1.382 | 31.78 |
| 0.945 | −1.590 | 36.15 |
| 0.939 | −1.820 | — |

TABLE 12
Calculation of m_{Angell} of Ad - 2

| T_{g}/T | Log (a_{T}) | d(log(a_{T}))/d(T_{g}/T) |
|---|---|---|
| 1.000 | 0.000 | m_{Angell} = 39.08 |
| 0.992 | −0.284 | 48.01 |
| 0.985 | −0.631 | 37.27 |
| 0.978 | −0.891 | 36.46 |
| 0.971 | −1.147 | 35.97 |
| 0.964 | −1.395 | 28.65 |
| 0.958 | −1.589 | 29.81 |
| 0.951 | −1.789 | 29.18 |
| 0.944 | −1.979 | 26.64 |
| 0.938 | −2.154 | 27.45 |
| 0.925 | −2.499 | — |

### REFERENCES FOR SUPPORTING INFORMATION FOR EXPERIMENTAL

### Example 2

(1) Sun, P. B. et al., J. Am. Chem. Soc. 2024, 146 (28), 19229-19238.
(2) Anastasaki, A. et al., J. Am. Chem. Soc. 2014, 136 (3), 1141-1149.
(3) Miller, K. A. et al., Chem. Commun. 2022, 58 (37), 5590-5593.

### EXAMPLE CLAUSES

The following clauses provide various examples of the present disclosure. However, the scope of the disclosure is not limited to any of the clauses listed herein.

1. A polymer network including one or more polymers and a fluxional carbon cage, wherein the fluxional carbon cage covalently crosslinks the one or more polymers to form the polymer network.

2. The polymer network of clause 1, wherein the fluxional carbon cage has the structure:

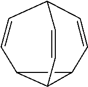

wherein carbons 1-10 of the fluxional carbon cage include a substituent selected from the group consisting of a hydrogen, a halogen, a hydroxyl group, an amino group, a carboxyl group, a carbonyl group, a nitro group, a thiol group, a cyano group, an alkyl group, and an aromatic group, and the fluxional carbon cage covalently crosslinked to the one or more polymers has the structure:

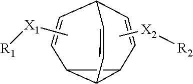

wherein X₁ and X₂ independently include a hydrocarbon chain, an aromatic group, an amino group, a sulfur(S), or an oxygen (O), and R₁ includes a first sidechain of the one or more polymers and R₂ includes a second sidechain of the one or more polymers.

3. The polymer network of clause 1 or 2, wherein the fluxional carbon cage includes a bullvalene, a barbaralyl cation, a barbaralyl radical, a barbaralane, a bullvalone, a barbaralone, or a semibullvalene.

4. The polymer network of any one of clauses 1-3, including the fluxional carbon cage in an amount of 1 mol % to 99 mol % of the polymer network.

5. The polymer network of clause 1, wherein the one or more polymers include at least one of an acrylate polymer, a polyester, a polysiloxane, a polyamide, a polyether, a polyolefin, a poly(vinyl ether), a polystyrene, a polyimide, a polysulfone, or a polyurethane.

6. The polymer network of clause 5, wherein the one or more polymers include alkyl polyacrylate, alkyl polymethacrylate, aryl polyacrylate, aryl polymethacrylate, or combinations thereof.

7. The polymer network of clause 5 or 6, wherein the one or more polymers include poly butyl acrylate or poly(methyl methacrylate).

8. A method of synthesizing the polymer network of any one of clauses 1-7, the method including: preparing a fluxional carbon cage crosslinker; combining the fluxional carbon cage crosslinker with monomers and/or one or more polymers and a free radical initiator to form a mixture; and exposing the mixture to thermal energy and/or electromagnetic energy to form the polymer network.

9. The method of clause 8, wherein the fluxional carbon cage crosslinker has the structure:

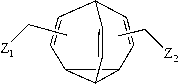

wherein the Z₁ and Z₂ include an acrylate group or a methacrylate group.

10. The method of clause 8 or 9, wherein the monomers include at least one of: an acrylate monomer, an epoxy monomer, a methacrylate monomer, a styrene monomer, an acrylamide monomer, a diene monomer, a vinyl acetate monomer, or a acrylonitrile monomer.

11. A composition including the polymer network of any one of clauses 1-7.

12. A thermosetting polymer including the polymer network of any one of clauses 1-7.

13. The thermosetting polymer of clause 12, including an elastomer or a resin.

14. A thermoplastic polymer including the polymer network of any one of clauses 1-7.

15. The thermoplastic polymer of clause 14, including an elastomer or a resin.

16. A force responsive material including: a polymer network including at least one polymer strand of one or more polymers covalently bound to a fluxional carbon cage, the at least one polymer strand configured to isomerize about the fluxional carbon cage by a sigmatropic rearrangement in response to a mechanical force acting upon the strand.

17. The force responsive material of clause 16, wherein an activation barrier of the fluxional carbon cage for the at least one polymer strand to isomerize about the fluxional carbon cage by a sigmatropic rearrangement in response to the mechanical force is in a range of 8 kcal/mol to 23 kcal/mol.

18. The force responsive material of clause 16 or 17, wherein, upon application of the mechanical force, the fluxional carbon cage isomerizes in the direction of a force vector of the mechanical force, thereby stiffening the force responsive material.

19. The force responsive material of any one of clauses 16-18, wherein the mechanical force includes a compressive force, a shear force, or a tensile force and wherein the mechanical force includes a static force, an oscillating force, a vibrational force, or an intermittent force.

20. A kit including a mixture of monomers, a fluxional carbon cage crosslinker, and a free radical initiator.

### CLOSING PARAGRAPHS

All references cited in the present disclosure are incorporated by reference herein in their entirety.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be used for realizing implementations of the disclosure in diverse forms thereof.

As will be understood by one of ordinary skill in the art, each implementation disclosed herein can comprise, consist essentially of or consist of its particular stated element, step, or component. Thus, the terms “include” or “including” should be interpreted to recite: “comprise, consist of, or consist essentially of.” The transition term “comprise” or “comprises” means has, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the implementation to the specified elements, steps, ingredients or components and to those that do not materially affect the implementation. As used herein, the term “based on” is equivalent to “based at least partly on,” unless otherwise specified.

Unless otherwise indicated, all numbers expressing quantities, properties, conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing implementations (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate implementations of the disclosure and does not pose a limitation on the scope of the disclosure. No language in the specification should be construed as indicating any non-claimed element essential to the practice of implementations of the disclosure.

Groupings of alternative elements or implementations disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

As used herein, the term “polymer” refers to a molecule made up of many repeating smaller molecular units of monomers, which are chemically bonded together in a chain. A homopolymer is a polymer made from a single type of monomer, while a copolymer is a polymer made from two or more different types of monomers. A polymer chain, or polymer strand, is a single chain molecule composed of repeating units. A polymer network is a three-dimensional structure where multiple polymer chains are interconnected via cross-links, often forming a single molecule. A polymer matrix is the continuous phase of a composite material, which acts as a binder and support for other components, such as fibers or filler particles, and is typically made of a polymer material, often a network polymer.

As used herein, the term “epoxy” refers to a class of reactive prepolymers and polymers that contain epoxide functional groups (i.e., oxirane rings). Epoxy can include resins that are cured (hardened) through a chemical reaction, often by mixing with a co-reactant called a hardener. The resulting material can be a tough, durable, thermosetting plastic with strength, adhesion, and heat and chemical resistant properties.

For the general chemical formulas provided herein, if no substituent is indicated, a person of ordinary skill in the art will appreciate that the substituent is hydrogen. A bond that is not connected to an atom, but is shown, indicates that the position of such substituent is variable. A jagged line, wavy line, two wavy lines drawn through a bond or at the end of a bond indicates that some additional structure is bonded to that position. For a great number of the additional monomers disclosed herein, but not explicitly shown in structures, it is understood by those in the art of polymers, that these monomers can be added to change the physical properties of the resultant polymeric materials even where the elemental analysis would not indicate such a distinction could be expected. Such physical properties include solubility, charge, stability, cross-linking, secondary and tertiary structure, and the like. Moreover, if no stereochemistry is indicated for compounds having one or more chiral centers, all enantiomers and diasteromers are included.

The term “halogen atom” or “halogen” as used herein, means any one of the radio-stable atoms of column 17 of the Periodic Table of the Elements, such as, fluorine, chlorine, bromine and iodine.

As used herein, the term “hydroxy” or “hydroxyl” group refers broadly to an —OH group.

The terms “amino,” “amino group,” and “unsubstituted amino” as used herein refer broadly to an —NH₂ group.

A “carboxy” or “carboxyl” group refers broadly to a carbonyl (—C═O) and a hydroxyl (—OH) group attached to the same carbon atom (—COOH).

A “carbonyl” group refers broadly to a —C═O group.

A “nitro” group refers broadly to an “—NO₂” group.

A “thiol” group refers broadly to a “—SH” group.

As used herein, a “cyano” group refers broadly to a “—CN” group.

As used herein, the term “alkyl” refers broadly to a fully saturated aliphatic hydrocarbon group. The alkyl moiety may be branched or straight chain. Examples of branched alkyl groups include iso-propyl, sec-butyl, t-butyl and the like. Examples of straight chain alkyl groups include methyl, ethyl, n-propyl, n-butyl, n-pentyl, n-hexyl, n-heptyl and the like. The alkyl group may have 1 to 30 carbon atoms (whenever it appears herein, a numerical range such as “1 to 30” refers broadly to each integer in the given range; e.g., “1 to 30 carbon atoms” means that the alkyl group may consist of 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 carbon atoms, although the present definition also covers the occurrence of the term “alkyl” where no numerical range is designated). The “alkyl” group may also be a medium size alkyl having 1 to 12 carbon atoms. The “alkyl” group could also be a lower alkyl having 1 to 6 carbon atoms. An alkyl group may be substituted or unsubstituted. By way of example only, “C₁-C₅ alkyl” indicates that there are one to five carbon atoms in the alkyl chain, e.g., the alkyl chain is selected from methyl, ethyl, n-propyl, isopropyl, n-butyl, isobutyl, tert-butyl, pentyl (branched and straight-chained), etc. Typical alkyl groups include methyl, ethyl, propyl, isopropyl, butyl, isobutyl, tertiary butyl, pentyl and hexyl.

As used herein, the term “alkene” refers to a hydrocarbon containing at least one carbon-carbon double bond (C═C). As used herein, an “alkenyl” refers to a univalent functional group or radical derived from an alkene by removing one hydrogen atom.

As used herein, the term “alkyne” refers to a hydrocarbon containing at least one carbon-carbon triple bond (C≡C). As used herein, the term “alkynyl” refers to a univalent functional group or radical derived from an alkyne by removing one hydrogen atom.

As used herein, “aryl” refers broadly to a carbocyclic (all carbon) monocyclic or multicyclic (such as bicyclic) aromatic ring system (including fused ring systems where two carbocyclic rings share a chemical bond) that has a fully delocalized pi-electron system throughout all the rings. The number of carbon atoms in an aryl group can vary. For example, the aryl group can be a C₆-C₁₄ aryl group, a C₆-C₁₀ aryl group or a C₆ aryl group. Examples of aryl groups include benzene, naphthalene and azulene. An aryl group may be substituted or unsubstituted. As used herein, “heteroaryl” refers to a monocyclic or multicyclic (such as bicyclic) aromatic ring system (a ring system with fully delocalized pi-electron system) that contain(s) one or more heteroatoms (for example, 1, 2 or 3 heteroatoms), that is, an element other than carbon, including nitrogen, oxygen and sulfur. The number of atoms in the ring(s) of a heteroaryl group can vary. For example, the heteroaryl group can contain 4 to 14 atoms in the ring(s), 5 to 10 atoms in the ring(s) or 5 to 6 atoms in the ring(s), such as nine carbon atoms and one heteroatom; eight carbon atoms and two heteroatoms; seven carbon atoms and three heteroatoms; eight carbon atoms and one heteroatom; seven carbon atoms and two heteroatoms; six carbon atoms and three heteroatoms; five carbon atoms and four heteroatoms; five carbon atoms and one heteroatom; four carbon atoms and two heteroatoms; three carbon atoms and three heteroatoms; four carbon atoms and one heteroatom; three carbon atoms and two heteroatoms; or two carbon atoms and three heteroatoms. Furthermore, the term “heteroaryl” includes fused ring systems where two rings, such as at least one aryl ring and at least one heteroaryl ring or at least two heteroaryl rings, share at least one chemical bond. Examples of heteroaryl rings include furan, furazan, thiophene, benzothiophene, phthalazine, pyrrole, oxazole, benzoxazole, 1,2,3-oxadiazole, 1,2,4-oxadiazole, thiazole, 1,2,3-thiadiazole, 1,2,4-thiadiazole, benzothiazole, imidazole, benzimidazole, indole, indazole, pyrazole, benzopyrazole, isoxazole, benzoisoxazole, isothiazole, triazole, benzotriazole, thiadiazole, tetrazole, pyridine, pyridazine, pyrimidine, pyrazine, purine, pteridine, quinoline, isoquinoline, quinazoline, quinoxaline, cinnoline and triazine. A heteroaryl group may be substituted or unsubstituted.

An “aromatic” group or compound refers broadly to a cyclic, planar, and fully conjugated system of atoms, most commonly a ring structure, for example benzene, toluene and the xylenes, with a delocalized pi electron cloud. In some cases, aromatic groups are hydrocarbons.

As used herein, a “hydrocarbon” or a “hydrocarbon chain” refer broadly to an organic compound that includes the elements carbon and hydrogen.

As used herein, the term “styrene” refers to an aromatic hydrocarbon compound with the chemical formula C₈H₈ (or C₆H₅CH═CH₂). Styrene is widely used as a monomer in the production of polystyrene plastics, synthetic rubber, and other copolymers.

As used herein, the term “acrylamide” refers to an organic compound with the chemical formula C₃H₅NO (or CH₂═CHCONH₂). Acrylamide is a vinyl-substituted primary amide and is primarily used industrially as a precursor to polyacrylamides.

As used herein, the term “diene” refers to an organic chemical compound that contains two carbon-carbon double bonds. The double bonds can be cumulative (adjacent), conjugated (separated by one single bond), or isolated (separated by two or more single bonds). Conjugated dienes are particularly important in organic chemistry due to their enhanced stability and unique reactivity in reactions like the Diels-Alder reaction.

As used herein, a “vinyl group” refers to a functional group in organic chemistry with the formula —CH═CH₂. It includes a methylidene bridge (a carbon with two hydrogen atoms) connected by a double bond to a methine bridge (a carbon with one hydrogen atom). The term “vinyl” is often used to refer to compounds that contain this group, such as styrene (vinylbenzene) or vinyl chloride, which can undergo polymerization reactions to form polymers like PVC (polyvinyl chloride).

As used herein, the term “acrylonitrile” is an organic compound with the chemical formula CH₂═CHCN. Acrylonitrile is an important monomer used to produce a variety of polymers and copolymers, including polyacrylonitrile (PAN), acrylonitrile butadiene styrene (ABS) plastic, and nitrile rubber.

As used herein, the term “functional group” refers any specific group of atoms within a larger molecule that is responsible for the characteristic chemical reactions of that molecule. Molecules with similar functional groups tend to have similar properties and react in similar ways. Examples include alcohols, aldehydes, ketones, carboxylic acids, esters, and amines, each with a specific atom or group of atoms that dictates a molecule's chemical properties, such as hydroxyl (OH) groups in alcohols, and carbonyl (C═O) groups in aldehydes and ketones. Other functional groups include alkenes and alkynes (with carbon-carbon double and triple bonds, respectively), ethers, amides, and halides.

Unless otherwise indicated, the practice of the present disclosure can employ conventional techniques of organic chemistry, inorganic chemistry, physical chemistry, analytical chemistry, and biochemistry. These methods are described in the following publications: see, e.g., McIntosh, Organic Chemistry: Fundamentals and Concepts, De Gruyter, 2018; Mohrig, Laboratory Techniques in Organic Chemistry, Fourth Edition, W.H. Freeman, 2014; McMurry, Organic Chemistry, Openstax, 2023; Carey, Advanced Organic Chemistry: Part A & Part B, Fifth Edition, Springer, 2007; Cotton and Wilkinson, Advanced Inorganic Chemistry, Sixth Edition, John Wiley & Sons, 1999; Atkins, P., De Paula, J., & Keeler, J. Atkins' Physical Chemistry, 11th ed., Oxford University Press, 2017; Harris, Quantitative Chemical Analysis, 10^{th} edition, W. H. Freeman and Company, 2020; and Voet et al., Fundamentals of Biochemistry, 4^{th} edition, Wiley, 2015.

Certain implementations are described herein, including the best mode known to the inventors for carrying out implementations of the disclosure. Of course, variations on these described implementations will become apparent to those of ordinary skill in the art upon reading the foregoing description. The inventor expects skilled artisans to employ such variations as appropriate, and the inventors intend for implementations to be practiced otherwise than specifically described herein. Accordingly, the scope of this disclosure includes all modifications and equivalents of the subject matter recited in the claims appended hereto as permitted by applicable law. Moreover, any combination of the above-described elements in all possible variations thereof is encompassed by implementations of the disclosure unless otherwise indicated herein or otherwise clearly contradicted by context.

What is claimed is:

1. A polymer network comprising:
one or more polymers and a fluxional carbon cage,
wherein the fluxional carbon cage covalently crosslinks the one or more polymers to form the polymer network.

2. The polymer network of claim 1, wherein the fluxional carbon cage has the structure: 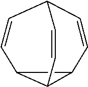
wherein carbons 1-10 of the fluxional carbon cage comprise a substituent selected from the group consisting of a hydrogen, a halogen, a hydroxyl group, an amino group, a carboxyl group, a carbonyl group, a nitro group, a thiol group, a cyano group, an alkyl group, and an aromatic group,
and the fluxional carbon cage covalently crosslinked to the one or more polymers has the structure: 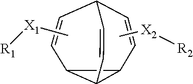
wherein X₁ and X₂ independently comprise a hydrocarbon chain, an aromatic group, an amino group, a sulfur (S), or an oxygen (O), and
R₁ comprises a first sidechain of the one or more polymers and R₂ comprises a second sidechain of the one or more polymers.

3. The polymer network of claim 1, wherein the fluxional carbon cage comprises a bullvalene, a barbaralyl cation, a barbaralyl radical, a barbaralane, a bullvalone, a barbaralone, or a semibullvalene.

4. The polymer network of claim 1, comprising the fluxional carbon cage in an amount of 1 mol % to 99 mol % of the polymer network.

5. The polymer network of claim 1, wherein the one or more polymers comprise at least one of an acrylate polymer, a polyester, a polysiloxane, a polyamide, a polyether, a polyolefin, a poly(vinyl ether), a polystyrene, a polyimide, a polysulfone, or a polyurethane.

6. The polymer network of claim 5, wherein the one or more polymers comprise alkyl polyacrylate, alkyl polymethacrylate, aryl polyacrylate, aryl polymethacrylate, or combinations thereof.

7. The polymer network of claim 6, wherein the one or more polymers comprise poly butyl acrylate or poly(methyl methacrylate).

8. A method of synthesizing the polymer network of claim 1, the method comprising:
preparing a fluxional carbon cage crosslinker;
combining the fluxional carbon cage crosslinker with monomers and/or one or more polymers and a free radical initiator to form a mixture; and
exposing the mixture to thermal energy and/or electromagnetic energy to form the polymer network.

9. The method of claim 8, wherein the fluxional carbon cage crosslinker has the structure: 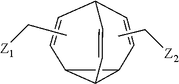
wherein the Z₁ and Z₂ comprise an acrylate group or a methacrylate group.

10. The method of claim 8, wherein the monomers comprise at least one of: an acrylate monomer, an epoxy monomer, a methacrylate monomer, a styrene monomer, an acrylamide monomer, a diene monomer, a vinyl acetate monomer, or a acrylonitrile monomer.

11. A composition comprising the polymer network of claim 1.

12. A thermosetting polymer comprising the polymer network of claim 1.

13. The thermosetting polymer of claim 12, comprising an elastomer or a resin.

14. A thermoplastic polymer comprising the polymer network of claim 1.

15. The thermoplastic polymer of claim 14, comprising an elastomer or a resin.

16. A force responsive material comprising:
a polymer network comprising at least one polymer strand of one or more polymers covalently bound to a fluxional carbon cage, the at least one polymer strand configured to isomerize about the fluxional carbon cage by a sigmatropic rearrangement in response to a mechanical force acting upon the strand.

17. The force responsive material of claim 16, wherein an activation barrier of the fluxional carbon cage for the at least one polymer strand to isomerize about the fluxional carbon cage by a sigmatropic rearrangement in response to the mechanical force is in a range of 8 kcal/mol to 23 kcal/mol.

18. The force responsive material of claim 16, wherein, upon application of the mechanical force, the fluxional carbon cage isomerizes in the direction of a force vector of the mechanical force, thereby stiffening the force responsive material.

19. The force responsive material of claim 16, wherein the mechanical force comprises a compressive force, a shear force, or a tensile force and wherein the mechanical force comprises a static force, an oscillating force, a vibrational force, or an intermittent force.

20. A kit comprising:
a mixture of monomers, a fluxional carbon cage crosslinker, and a free radical initiator.
